(19) United States
(12) Patent Application Publication
(10) Pub. No.: US 2026/0352287 A1
(43) Pub. Date: Nov. 5, 2026

(54) FAST AND EARLY BEAM REFINEMENT IN CELLULAR COMMUNICATIONS

(71) Applicant: INTERDIGITAL PATENT HOLDINGS, INC., Wilmington, DE (US)

(72) Inventors: Jaya RAO, Montreal (CA); Paul MARINIER, Brossard (CA); Umer SALIM, Vallauris (FR); Ananth KINI, Conshohocken, PA (US); Faris ALFARHAN, Montreal (CA); Janet STERN-BERKOWITZ, Little Neck, NY (US)

(21) Appl. No.: 19/198,683

(22) Filed: May 5, 2025

(51) Int. Cl. H04B 7/06; H04W 74/0833

(52) U.S. Cl. CPC H04B 7/0626; H04B 7/06952; H04W 74/0833

(57) ABSTRACT

Disclosed procedures, methods, architectures, apparatuses, systems, devices, and computer program products relate to beam refinement in cellular communications. In exemplary implementations, configurations and methods for performing fast and early beam refinement during an initial channel access procedure are disclosed. In exemplary implementations, beam refinement is based on channel state information (CSI) measurements performed by User Equipment (UE) on reference signal beams transmitted in a cell of a wireless cellular network.

### BACKGROUND

The present disclosure is generally directed to the fields of communications, software and encoding, including, for example, to methods, architectures, apparatuses, and systems related to beam refinement in cellular communications systems and methods.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely, Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates Synchronization Signal Block (SSB) beam sweeping within an SSB burst; and

FIG. 3 illustrates a Channel State Information (CSI) based Random Access Channel (RACH) procedure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and'or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

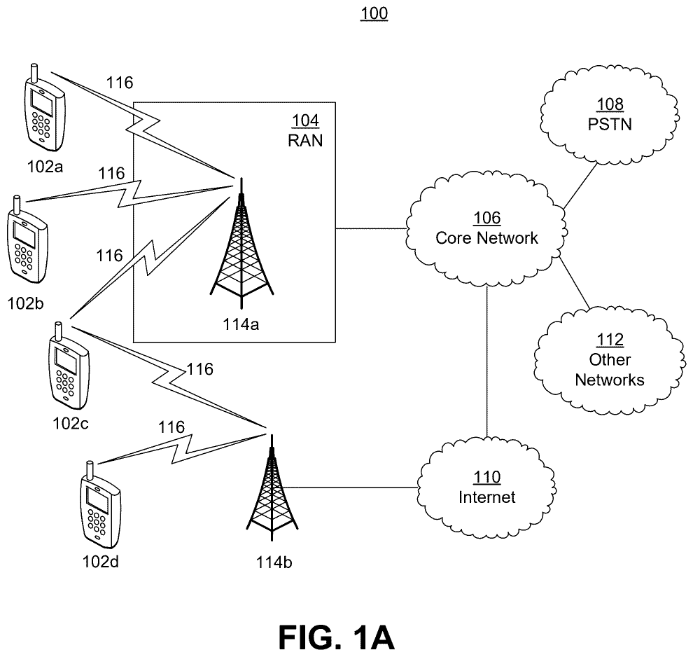

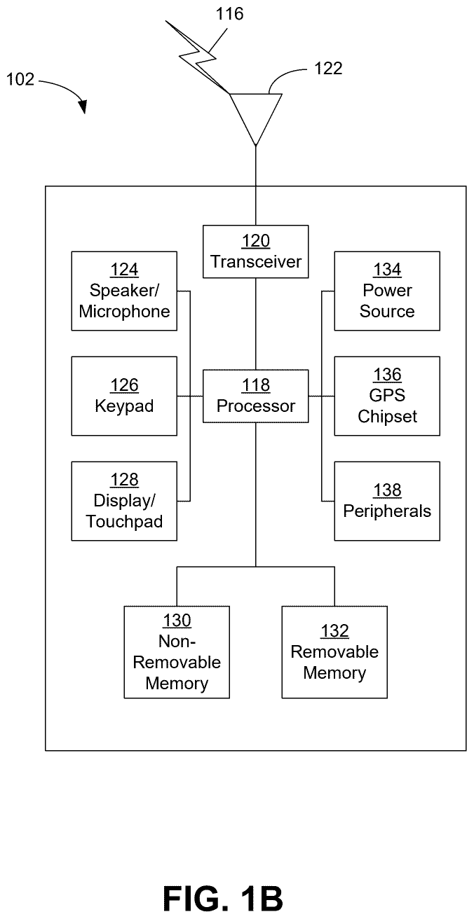

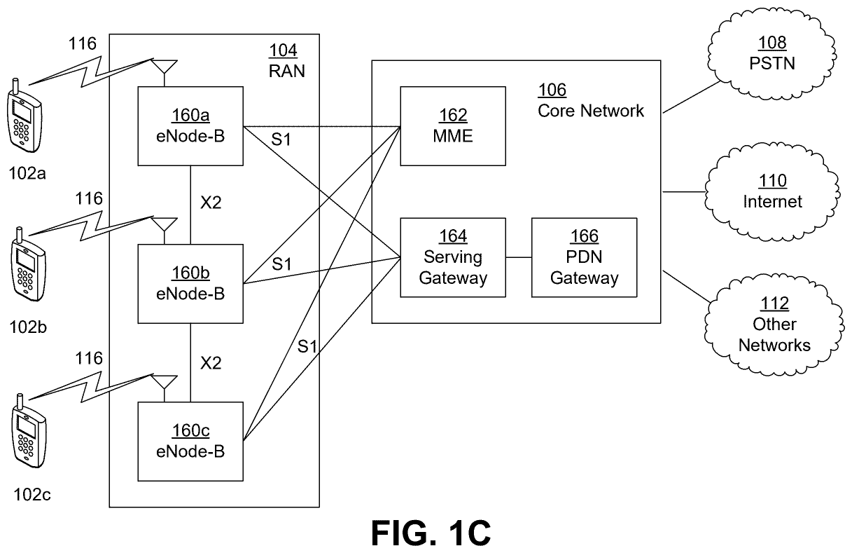

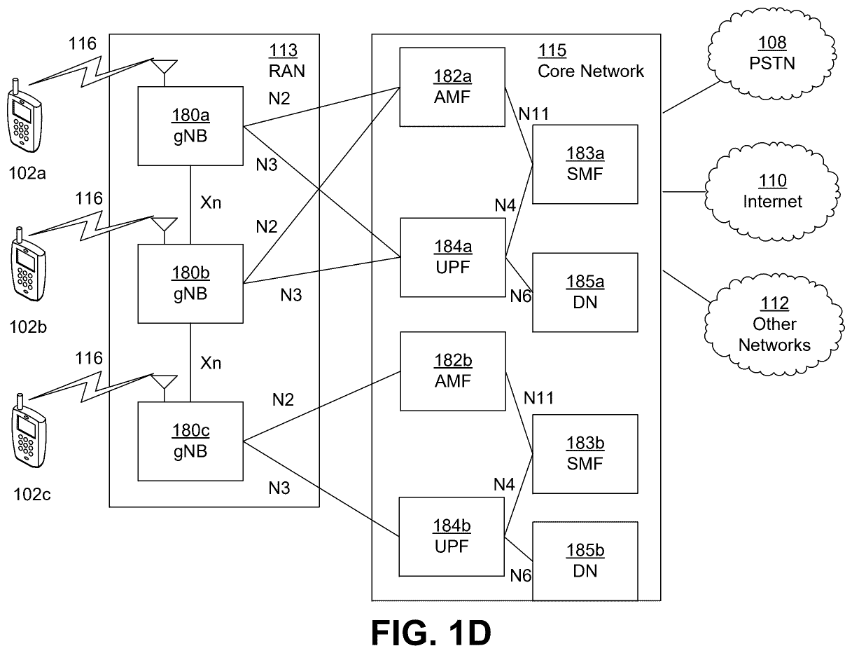

The methods, apparatuses and Systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, 2 core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (NB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies. which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High Speed Packet Access (HSPA) and/or Evolved HSPA (HSPA+). HSPA may Include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR. Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e. Worldwide Interoperability for Microwave Access (WiMAX), CDMA2000, CDMA2000 1X, CDMA2000 EV-DO, Interim Standard 2000 (IS-2000). Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment the base station 114b and the WTRUs 102c, 102d my implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LIE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology,

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite, The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B. the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1D depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 1140) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from the speaker microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non removable memory 130 and/or the removable memory 132. The non-removable memory 130 may include random access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zine (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules units that provide additional features, functionality and/or wired o wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature senso a time sensor a colocation sensor an altimeter, a light sensor, a touch sensor, a magnetometer, a barometer, a gesture sensor, a biometric sensor, and/or a humidity sensor.

The WTRU 102 may include a full duplex radio for which transmission and reception of some of all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that. the RAN 104 may include any number of Node-Bs while remaining consistent with an embodiment. The eNode-Bs 160a, 160b, 160c may each include one or more transceivers for communicating with the WTRUs 102a, 102b. 102c over the air interface 116. In an embodiment the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like, The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a. 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAS that originates from outside the BSS may arrive through the AP and may be delivered to the STAS. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DELS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating a RAN 113 and a CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180b, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b. 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe er transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gMBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102e may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more eNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SME 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (MBB) access-services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an No interface between the UPF 184a, 184b and the DN 185a, 185b.

In view of FIGS. 1A-1D, and the corresponding description of FIGS. 1A-1D, one or more, or all, of the functions described herein with regard to any of WTRUs 102a-d, base stations 114a-b. eNode-Bs 160a-c, MME 162, SGW 164, PGW 166, NBs 180a-c, AMFs 182a-b, UPFs 184a-b. SMFs 183a-b, DNs 185a-b, and/or any other element(s)/device(s) described herein, may be performed by one or more emulation elements devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented deployed as part of a wired and/or wireless communication network. The emulation device may be directly coupled to another device for purposes of testing and/or may performing testing using over the air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Network Energy Savings

Current standards enable the network (NW) to minimize its energy consumption due to transmissions and receptions. Such network energy savings (NES) capabilities include performing adaptations in multiple domains including, for example powering of subsets of antenna ports, elements or panels, in the spatial domain (SD); applying cell Discontinuous Transmission (DTX) and/or Discontinuous Reception (DRX) or applying long periodicity for Synchronization Signal Block (SSB) transmissions, in the time domain (TD); disabling certain carriers or Bandwidth Parts (BWPs), in the frequency domain (FD); and/or applying lower power offset values, in the power domain (PD).

While the NES enhancements supported in 5G R18 and R19 were specified with the assumption that the NW is lightly or moderately loaded in terms of achievable throughput by the UEs in cells, future releases or generations are expected to support more advanced capabilities and features for NES, even in high load scenarios. It is desirable to minimize the transmission of always-on signals or channels such as SSBs. It is also desirable to use energy efficient SSB implementations in certain scenarios (such as initial access) so that fast and early measurements on SSB beams for beam refinement and selection can be performed.

In current implementations, however, initial access, such as with a Random Access Channel (RACH) procedure, is typically performed on wide SSB beams that are received with relatively high periodicity (e.g., 20 ms), e.g., when the UE is in IDLE mode.

Channel State Information (CSI) measurements and reporting, for identifying suitable narrow beams, are done only after the UE transitions to the CONNECTED mode, prior to the subsequent PDSCH/PUSCH transmissions.

Consider a cell in which NES is implemented (e.g., an NES cell) that transmits always-on SSBs (AO-SSBs) and new (i.e., yet to be specified by standard) or 6G SSBs, such as on-demand SSBs (OD-SSBs) and one-shot SSBs (OS-SSBs). In other words, the cell transmits;
A first type of SS beams (e.g., SS-a, AO-SSBs)
   Signals transmitted: PSS, SSS, light sync signals, MIB, DMRS-PBCH, PBCH payload (MIB information, SFN)
   Beamwidth: Wide beams transmitted in multiple directions for coverage
   Transmission type: Always-on, periodic
   Burst periodicity: Longer relative to the periodicity of second SS beams (e.g., 160 ms)
A second type of SS beams (e.g., SS-b, new/6G SSBs, OD-SSBs)
   Signals: Light sync signals (e.g., sync signals that may use limited sequence length and/or resources), PBCH with smaller payload (e.g., beam index) relative to PBCH of first SS type, CSI-RS sequence
   Beamwidth: Narrow beams (e.g., associated with wide beam of first SS type) transmitted in a subset of directions (e.g., direction of UE)
   Transmission type: On demand, semi-persistent or aperiodic
   Burst periodicity: Shorter relative to the periodicity of first SS beams (e.g., *<=20 ms)
As for a UE, a UE (e.g., in IDLE mode or CONNECTED mode) may be predefined or indicated (e.g., via SIB) the parameters of SS-a and SS-b configurations and information on how SSB-a and SSB-b are associated.

A UE is expected to perform L1 measurements with low latency (e.g., for beam refinement) on dynamically signaled CSI resources (e.g., narrow SS beams) received from an NES cell, such as during a system/initial access procedure.

One or more problems may arise when a UE in IDLE or CONNECTED mode is triggered to perform system/cell access procedure (e.g., for cell (re)selection or cell switch). In such a scenario:
The cell may transmit wide SSB beams (SS-a beams) with longer periodicity (>160 ms, e.g., in 6G) for high network energy savings (NES) (e.g., 7%).
The expected increase in latency during system access and subsequent beam refinement before performing transmissions on narrow beams for transmissions on PDSCH/PUSCH may be unacceptable (e.g., for 6G services).

It is desirable to enable fast and early CSI acquisition and beam refinement based on new SSBs with properties different than those of SSBs transmitted by current systems. Fast and early CSI acquisition and beam refinement may include carrying out CSI acquisition and beam refinement while a UE is in IDLE mode, before entering CONNECTED mode.

It is also desirable for UEs to perform beam specific measurements and reporting for enabling low idle-to-PDSCH time (e.g., during initial access or when accessing a cell that is transmitting sparse SSBs).

### Applicable Terminology and Concepts

The following terminology is used and can be assumed throughout this disclosure:
Synchronization Signal Block (SSB) or SS/PBCH block may include at least one of the following: synchronization signals such as PSS (Primary Synchronization Signal) and SSS (Secondary Synchronization Signal), Physical Broadcast Channel PBCH (Data), Master information block (MIB) and PBCH (DMRS). SSBs may be transmitted by the NW node (e.g., base station, TRP, relay node, RIS unit) in different directions as SSB beams in bursts. The number of SSB beams in an SSB burst set, which may be transmitted periodically within an interval (e.g., 5 ms) may depend on the carrier frequency. For example, an SSB burst may contain 4 SSBs for FR1 (<3 GHz), 8 SSBs for FR1 (3 to 6 GHz) and 64 SSBs for FR2. Certain SSBs may be transmitted as on-demand SSBs (OD-SSBs). which may consist of a subset of SSBs in a burst. Such OD-SSBs may be transmitted aperiodically, semi-persistently, or periodically with certain periodicity. The transmission of such OD-SSBs may be triggered by the NW node or UE (e.g., via transmission of a UL WUS). Some SSBs may include slim/lean SSBs, which may comprise PSS only, PSS and SSS only, PBCH or a subset of MIB only, for example.
CSI-RS: channel state information reference signal may include at least one of the following: CSI-RS resource set (ID), CSI-RS resource (ID/index), resource mapping, power control offset values (e.g., with respect to PDSCH, SSB), scrambling ID, periodicity, offset and quasi-colocation (QCL) information. CSI-RS may be transmitted in DL by the NW node as CSI-RS beams, via different resource types including periodic, semi-persistent and aperiodic.
CSI: channel state information may include at least one of the following: channel quality index (CQI), rank indicator (RI), precoding matrix index (PMD, an L1 channel measurement (e.g., RSRP such as L1-RSRP, or SINR), CSI-BS resource indicator (CRI), SS/PBCH block resource indicator (SSBRI), layer indicator (LI) and/or any other measurement quantity measured by the UE from the configured CSI-RS or SS/PBCH (SSB) block.

A property of scheduling information (e.g., an uplink (UL) grant or a downlink (DL) assignment) may consist of at least one of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; whether the grant is a configured grant type 1 (i.e., UE immediately using the configured UL resources after receiving the configuration information), type 2 (i.e., UE waiting until an explicit MAC CE indication before using the configured UL resources), or a dynamic grant.

An indication may consist of at least one of the following: an explicit indication by a DCI field or by RNTI used to mask CRC of the PDCCH; an implicit indication by a property such as DCI format, DCI size, Coreset or search space aggregation level, identity of first control channel resource (e.g., index of first CCE) for a DCI, where the mapping between the property and the value may be signaled by RRC or MAC; or an explicit indication by a DL MAC CE.

Throughout the embodiments described herein, the network may include any of a base station (e.g., gNB, TRP, RAN node, access node, NTN node, IAB node, RIS unit/node), core network function (e.g., AMF, SMF, PCF, NEF) and application function (e.g., edge server function, remote server function), for example. NES cells may refer to any of the network nodes that may be operating in an NES state/mode, including any of time, frequency, spatial and/or power domain adaptation modes.

Throughout the embodiments described herein, NES adaptations may include any of the adaptations at the network in the: spatial domain (e.g., power off subsets of antenna ports, elements or panels), time domain (e.g., (de)activation of cell DTX/DRX, apply long periodicity or sparse transmissions of common signals/channels), frequency domain (e.g., disable certain carriers or BWPs), or power domain (e.g., apply lower power offset values).

### Synchronization Signals and Procedures in 5G NR

Downlink Synchronization is the process in which UE detect the radio frame boundary (i.e., the exact timing when a radio frame starts) and OFDM symbol boundary (i.e., the exact timing when an OFDM symbol starts). This process is done by detecting and analyzing SSB(x).

### SSB

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations need not be unique, i.e., different SSBs in the frequency domain can have different PCIs. However, when an SSB is associated with an RMSI, the SSB is referred to as a Cell-Defining SSB (CD-SSB). An SpCell is always associated to a CD-SSB located on the synchronization master.

Polar coding is used for PBCH. The UE may assume a band-specific sub-carrier spacing for the SSB unless a network has configured the UE to assume a different sub-carrier spacing. PBCH symbols carry their own frequency multiplexed DMRS. QPSK modulation is used for PBCH.

### Cell Search

Cell search is the procedure by which a UE acquires time and frequency synchronization with a cell and detects the Cell ID of that cell NR cell search is based on the primary and secondary synchronization signals, and PBCH DMRS, located on the synchronization raster.

### System Information

System Information (SI) is divided into the Master Information Block (MIB) and a number of System Information Blocks (SIBs) where:
the MIB is always transmitted on the BCH with a periodicity of 80 ms and repetitions made within 80 ms (as specified in TS 38.212) and it includes parameters that are needed to acquire SIB1 from the cell.
the SIB1 is transmitted on the DL-SCH with a periodicity of 160 ms and variable transmission repetition periodicity within 160 ms (as specified in TS 38.213). The default transmission repetition periodicity of SIB1 is 20 ms but the actual transmission repetition periodicity is up to network implementation.
the MIB and SIB1 make up the minimum system information (MSD) required to operate on a cell.

The MIB on PBCH provides the UE with parameters (e.g., CORESET #0 configuration) for monitoring of PDCCH for scheduling PDSCH that carries SIB1. The PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which the SSB is detected.

### SSB Indexing and SSB Burst

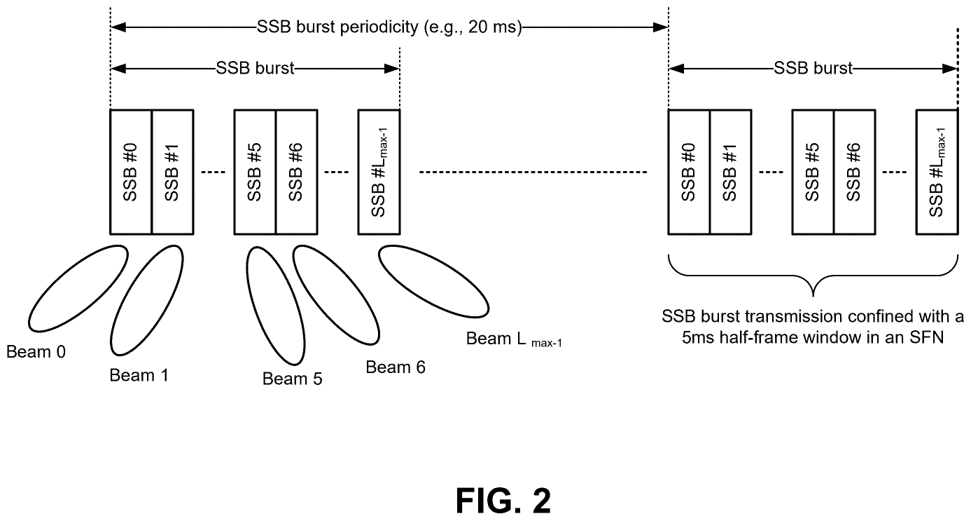

Each SSB within an SSB Durst set (i.e., all of the SSBs within the 5 ms period of the SSB transmission) is assigned a unique number starting from 0 and increasing by 1. This number resets to 0 in the next SSB burst set (i.e., next 5 ms span after the SSB transmission cycle, e.g., after the default cycle of 20 ms). This unique number (i.e., SSB Index) is information provided to the UE via PBCH DMRS and/or via PBCH payload. The candidate SSBs in a half frame are indexed in an ascending order in time from 0 to L−1. A UE shall determine the 2 LSB bits, for L=4, or the 3 LSB bits, for L>4, of a SSB index per half frame from a one-to-one mapping with an index of the DMRS sequence transmitted in the PBCH. For L=64, the UE shall determine the 3 MSB bits of the SS/PBCH block index per half frame by PBCH payload bits. FIG. 2 shows an SSB burst with a periodicity of 20 ms.

### Common Search Space

Upon detection of an SSB, the UE determines from the MIB that a CORESET for Type 0-PDCCH common search space (CSS) set is present if the SSB subcarrier offset (k_{SSB})<24 for FR1 or if k_{SSB}<12 for FR2. The UE determines from the MIB that a CORESET for Type0-PDCCH CSS set is not present if k_{SSB}>23 for FR1 or if k_{SSB}>11 for FR2; the CORESET for Type0-PDCCH CSS set may be provided by PDCCH-Configuration.

PDCCH-Configuration in the MIB is indicated by 8 bits, where the 4 LSB bits indicate the CORESET multiplexing pattern corresponding to search space (SS) 0 and the 4 MSB bits indicate the CORESET 0.

For SSB and CORESET multiplexing pattern 1, the SIB1 repetition transmission period is 20 ms. For SSB and CORESET multiplexing pattern 2 or 3, the SIB1 transmission repetition period is the same as the SSB period (as specified in TS 38.213). SIB1 includes information regarding the availability and scheduling (e.g., mapping of SIBs to SI message, periodicity, SI-window size) of other SIBs with an indication whether one or more SIBs are only provided on demand and, in that case, the configuration needed by the UE to perform the SI request. SIB1 is a cell-specific SIB.

### Definition of Beam

A UE may transmit or receive a physical channel or reference signal according to at least one spatial domain filter. The term “beam” may be used to refer to a spatial domain filter. The UE may transmit a physical channel or signal (e.g., PUCCH, PUSCH, SRS) using the same spatial domain filter as the spatial domain flier used for receiving an RS (such as CSI-RS) or an SS block. The UE transmission may be referred to as “target”, and the received RS or SS block may be referred to as “reference” “source.” In such case, the UE may be said to transmit the target. physical channel or signal according to a spatial relation with a reference to such RS or SS block.

The UE may transmit a first physical channel or signal according to the same spatial domain filter as the spatial domain filter used for transmitting a second physical channel or signal. The first and second transmissions may be referred to as “target” and “reference” (or “source”) respectively. In such case, the UE may be said to transmit the first (target) physical channel or signal according to a spatial relation with a reference to the second (reference) physical channel or signal. A spatial relation may be implicit, configured by RRC or signaled by MAC CE or DCI. For example, a UE may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

The UE may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the UE is configured with a quasi-colocation (QCL) assumption type D between corresponding antenna ports. Such association may be configured as a TCI (transmission configuration indicator) state. An indication to a UE of an association between a CSI-RS or SS block and a DM-RS may be by an index to a set of TCI states configured by RRC and/or signaled by MAC CE. Such indication may also be referred to as a “beam indication.”

Herein, an SSB may refer to one or more SSB beams (spatial relation) within a collection of SSBs (SSB burst). An SSB may refer to a beam-and vice-versa-or a CSI-RS resource related to the beam. SSB, SSBs, and/or SSB burst may loosely refer to one or more beams transmitted from a TRP or a network node.

Throughout this disclosure, the terms ‘RS’, ‘RS Beams’, ‘SSB’, SS beams and ‘SSB beams’ may be used interchangeably. The terms SS-a, type-1 SSBs may be used interchangeably. The terms SS-b, type-2 SSBs may be used interchangeably. Also, the terms ‘RS configuration, ‘RS beam config’, ‘NES-RS config’, ‘SSB pattern’ and ‘SSB config’ may be used interchangeably.

### RACH Procedure in 5G

The RACH procedure allows a UE to establish or re-establish a connection with a cell or base station. It may be used for initial access, timing advance, synchronization, handover, resuming connectivity (e.g., recovery from RLF or beam failure) or on-demand SI. The RACH procedure may be configured as contention-based (CBRA) or contention-free (CFRA).
In step 1 (e.g., of a 4-step RACH procedure), the UE may select a random access preamble from a predefined set (e.g., of up to 64 preambles). The preamble may be transmitted on the Physical Random Access Channel (PRACH) in a specific time-frequency resource. The UE may use the SSB) or CSI-RS to determine the best beam and PRACH occasion. The transmitted PRACH may be detected by the gNB and used for estimating the UE's timing advance.
In step 2 of the RACH procedure, the UE may receive in a RAR window, via the Physical Downlink Control Channel (PDCCH) and Physical Downlink Shared Channel (PDSCH), a Random Access Response (RAR) message. The RAR may include the detected preamble ID (RAPID), timing advance (TA) command for uplink synchronization, an uplink grant for Msg3 transmission and a temporary Cell Radio Network Temporary Identifier (TC-RNTI). If no RAR is received, the UE may retransmit the preamble (up to a configured maximum).
In step 3 of the RACH procedure, the UE may transmit a message on the Physical Uplink Shared Channel (PUSCH) using the uplink grant from Msg2. The Msg3 may contain UE-specific information, such as a UE identity (e.g., C-RNTI or random value) and a connection request or scheduling request. In the case of CBRA, collisions may occur if multiple UEs use the same preamble and resource.
In step 4 of the RACH procedure, the UE may receive a contention resolution message via PDSCH. For CBRA, Msg4 may include the UE's identity from Msg3 to resolve collisions. The UE may confirm successful contention resolution if its identity matches and the TC-RNTI may be promoted to a C-RNTI for future communication. For CFRA, step 4 is typically not needed as no contention occurs.

### Configuration Information Associated With RS/SS

In one solution, the UE may be preconfigured and/or receive configuration information, and/or sub-configurations (e.g., subset of parameters associated with a configuration) associated with reference signals (RS) or beams. Such RSs/beams (e.g., applicable in DL) may include any of the following:
First type of SS beams, SS-a
   Signals: one or two sync signals (e.g., PSS/SSS, sync signals that may use longer sequence length and/or resources), first PBCH type which may contain a larger PBCH payload (e.g., MIB, SFN information), PBCH-DMRS, MIB, pre-SIB, SI
   Periodicity: longer relative to the periodicity of SS-b (e.g., Periodicity of SS-a is >=160 ms)
   TD properties: may be in any SFN/half-frame/subframe slot (for flexibility)
   SCS: may or may not have the same subcarrier spacing (SCS) as that of SS-b or legacy SCS values (e.g., 15 kHz, 30 kHz, . . . )
   FD properties: on/off sync master (e.g., 5G/6G bands, perched carriers, anchor carriers)
      Different SS-a configurations on different carriers may overlap/aligned in TD
      In some deployments (e.g., small cell), SS-a on different carriers may not overlap in TD.
   SD/beam properties: wide beams (typical, transmitted in multiple directions for coverage) and narrow beams
   Transmission type: Always-on (for coverage), periodic, on-demand (NW-triggered, UE triggered)
   Usage: IDLE mode (sync, camping, initial/system access, RACH) and CONNECTED mode (L1/L3 RRM measurements)
   New RS/SSBs that may include additional/lower set of resources/signals than those in legacy SSBs, including a combination of PSS/SSS, MIB, PBCH, pre-SIB1, SIB1, RACH configuration, UL WUS configuration, PUCCH resource configuration, SDT resources, SRS resources, etc.
Second type of SS beams, SS-b
   Signals: light sync signals (e.g., one or two sync signals that may use limited sequence length and/or resources) and a second PBCH type, which may be referred to herein as a light PBCH (e.g., contains small payload)
   Periodicity: shorter relative to the periodicity of SS-a (e.g., periodicity of SS-b is 20 ms)
   TD properties: may be located on even/odd SFNs, first/second half-frame index, set of OFDM symbols in a slot subframe.
   SCS: may or may not have the same subcarrier spacing (SCS) as that of SS-a or legacy SCS values (e.g., 15 kHz, 30 kHz, . . . ).
   FD properties: on/off sync raster (e.g., 5G/6G bands, perched carriers), may or may not overlap in FD with SS-a (e.g., located on same different carriers than SS-a)
   SD/beam properties: narrow beams (e.g., typical, may or may not have the same QCL assumption as SS-a beams) and wide beams
   Type: Always-on periodic (e.g., for coverage), semi-persistent, on-demand (NW-triggered, UE triggered)
   Usage: Assist IDLE mode (camping, T/F sync, initial access, access SI), CONNECTED mode (e.g., for L1 measurements, mobility, RLM/BM)
Legacy NR/5G SSB
   Cell defining SSBs (CD-SSB) or non-cell defining SSBs (NCD-SSBs)
   Frequency locations of the SSBs that are on and off sync raster (e.g., GSCN, ARFCN or other sync raster)
Measurement RS, e.g., SS-a, SS-b, DMRS, CSI-RS, TRS, PTRS
NES-RS, including:
   On-demand SSBs (OD-SSBs) that may be available in a certain duration/window with certain periodicity/inter-burst gap, from a reference/start time onwards
   UE/group-specific RS (e.g., a set of RS beams that may be triggered/transmitted for a UE/UE group)
Light-RS
   RS that may contain a combination of one or more sync signals, PSS, SSS, discovery reference signal (DRS), PBCH only, or SIB1 only.

Such configuration for RS (RS configuration) may be applicable for supporting one or more NES adaptations in different combinations of any of time, frequency, spatial, and power domains, for example. Such configurations parameters may be applicable for any of the embodiments described herein. As used herein, the terms ‘NES-RS’, ‘Enhanced RS’, ‘measurement RS’ and ‘light RS’ may be used interchangeably when referring to any reference signals that may or may not be identical to legacy SSBs. In the examples described herein, the terms ‘SSB’, ‘SS’ and ‘RS’ may be used interchangeably. Additionally, the term ‘SS/RS config’ may apply to any of SS-a and SS-b configurations. In the examples described herein, the terms ‘SS-a’, ‘SS-a signals’, ‘SS-a beams’ and ‘SS-a transmissions’ may be used interchangeably, to refer to any of the signals or transmissions associated with SS-a. The same applies for SS-b.

In the examples described herein, the term ‘CSI-based RACH’ may refer to any functionalities associated with capabilities, transmitting a request or receiving configuration/indications that may be related to performing CSI measurements reporting, and/or beam refinement/selection during a RACH procedure. Similarly, the term ‘on-CSI-based RACH’ may refer to any functionalities associated with system/initial access procedures or RACH procedures, where there may be no CSI measurements and/or beam refinement done during initial access or before an initial access procedure is completed.

The configurations/sub-configurations associated with SS/RS, at least in part, may received in broadcast transmission (e.g., PBCH, MIB, SI, SIBx) or in dedicated RRC signaling (e.g., in RRCReconfiguration message) during CONNECTED mode or in INACTIVE/IDLE mode (e.g., RRCRelease message, when transitioning from CONNECTED mode to INACTIVE mode, in PCBH, paging DCI in IDLE mode). Alternatively, any of the configurations, sub-configurations and parameters may be received by the UE, at least in part, in one or more dynamic signaling indications (e.g., in MAC CE or DCI) or in NES/cell activity indications, for example. Such NES/cell activity indications may be received in RRC signaling, MAC CE, DCI (e.g., UE-specific or group common DCI) or PDSCH, for example. In exemplary embodiments, the UE may receive a first subset of parameters associated with one or more RS configurations in PBCH/MIB/SIBx/RRC signaling and a second subset of parameters or an update of the parameters the first subset may be received in dynamic signaling (e.g., MAC CE, DCI).

The UE may receive, in configuration information, one or more of the following parameters associated with the SS/RS configuration or sub-configurations:
Indexes/IDs of one or more SS/RS configurations (e.g., SS-a configuration, SS-b configurations), SS/RS beams, SS/RS resource sets or resources
SSB/RS resources:
   Time domain resources: number of symbols per slot (e.g., 1, 2, 4 symbols per slot), start offset symbol, repetition factor, burst periodicity, duration window of RS transmission, time gap between beams/RS/bursts, comb/interleaving pattern.
      When the RS configurations correspond to an SS configuration/pattern, the configuration/pattern may indicate the candidate locations of the SS in one or more bursts in terms of any of the following parameters: SFN index (e.g., even or odd indexes), half-frame index (e.g., first or second half of a frame). subframe, slot, symbol.
   Frequency domain resources: number of PRBs, center frequency, start offset PRB (e.g., from a reference location), repetition factor, comb pattern, master location (e.g., on GSCN, ARFCN, carrier) whether resources are on/off sync raster.
      In exemplary embodiments, a subset of SS/RS (e.g., SS-a) may be transmitted on a carrier (e.g., perched carrier that may be located on sync raster), that may be different than the carrier (e.g., anchor carrier) where other subsets of SS/RS (e.g., SS-b) may be located. For example, a UE in IDLE mode may locate SS-a on the perched carrier (e.g., for sync) and relocate to SS-b on the anchor carrier (e.g., for initial access).
   Spatial domain resources indexes of SS beams, number of SS/beams in a burst. position of SS in a burst (e.g., bitmap), beamwidth of SS beams (e.g., wide-beams, narrow beams), number of bursts (e.g., in a time widow associated with a timer).
   Each SS/RS config/sub-configuration may include resources which may or may not overlap with the resources in other RS configurations/sub-configurations, for example.
   In exemplary embodiments, the resources allocated for one or more RS configurations/sub-configurations may correspond to an RS resource pool.
SSB/RS ports
   Number and set of transmit and/or receive ports
Resource type
   Corresponds to the time domain property of SS/RS resource configuration, which may be periodic, semi-persistent, aperiodic or on-demand (e.g., NW-triggered, UE-triggered)
Active SS/RS resources in a burst
   For an SS configuration, this parameter may indicate the SS positions in a burst, e.g., SS beam indexes that are active.
   The active SSBs in a burst (index of SSs that are transmitted) may be indicated via bitmap with different lengths, e.g., bitmap length of 4 bits may be used for FR1 when there may be 4 SSBs in a burst. Bit value ‘1’ may indicate an SSB is active/transmitted and bit value ‘0’ may indicate the SSB is off.
Periodicity
   For an SS configuration, the parameter may indicate the periodicity of SS bursts on a cell (e.g., 5 ms, 20 ms, 160 ms).
Usage type
   UE may be configured with any of
      synchronization, cell (re)selection, initial access, paging (e.g., for IDLE mode)
      beam management, RLM, NES, codebook/non-codebook, antenna switching for using such RS (e.g., for CONNECTED mode)
Slot level periodicity and slot level offset, e.g., for periodic or semi-persistent RS
SS/RS resource/beam bandwidth
Subcarrier spacing (SCS)
   UE may be configured with any of the SCS values (e.g., per SS/RS type of configuration) associated with the numerology of the time/frequency resources, including, for example, 15 kHz, 30 kHz, 60 kHz, 120 kHz, 240 kHz,
   The SCS configured for SS-a may be the same or different than the SCS configured for SS-b. In exemplary embodiments, SS-a may be configured with N1 beams on SCS1 and SCS-b may be configured with N2 beams with SCS2
Frequency hopping information;
   UE may be configured with one or more hopping patterns that may be applied over a set of RS resources in any of the time, frequency, and spatial domains
   In a hopping pattern, the RS resources (e.g., for SS-a, SS-b) may be located in time and/or frequency location, where the resource may or may not overlap in time and frequency domains (e.g., SS-b may be at frequency F1 and F2 in time T1, at frequency F1 at time T2, at frequence F1 and F2 at T3, . . . ).
   In a hopping pattern, a partial set of RS resources in frequency domain (e.g., PRBs) may be used in each time domain resource (e.g., symbol) for transmitting/receiving the RS using different spatial relation. Such hopping pattern may correspond to one or more NES adaptation/state, for example.
Guard period
   A UE may apply the guard period when switching between different RS configurations/sub-configurations or when switching between different Rx ports for the RS reception. The guard period may be indicated as a number of symbols/slots/ms.
SS/RS Comb Pattern Information
   A parameter may include transmission comb value, which may be associated with the gap in terms of the number of PRBs or number of symbols/slots between two RS resources in the frequency and/or time domains.
   Each RS configuration may include one or more RS comb patterns, where each pattern may be associated with a different set of parameters (e.g., offset value, cyclic shift) and/or RS resources in the time frequency/spatial domains.
   A comb pattern may include RS resource in different symbols (within one slot or across multiple slots) or slots, where the RS in different symbols/slots may be received with different spatial relation filter.
   When RS is configured with periodic or semi-persistent RS resources, the RS comb pattern (e.g., using resources in time, frequency, spatial domains) may be repeated in each period.
   When RS is configured with aperiodic RS resources, the RS burst may consist of RS resources in time, frequency, spatial domains.
Comb offset hopping pattern with repetition
Sync signals
   The sequences used (e.g., m-sequence, Zadoff-Chu sequence) for the sync signals in SS-a may be the same or different than the sequences in the sync signals of SS-b.
   In exemplary embodiments, the sequences used for sync signals in SS-a may be of a different format (e.g., short format) than those in SS-b (e.g., long format), e.g., possibly to enable fast synchronization.
   The resources (e.g., in terms of number of subcarriers and/or symbols) used for the sync signals in SS-a may be lower/higher/same compared to the resources used for the sync signals in SS-b.
Beam transmit power
   May include the transmit power applied per RS signal/resource/beam/burst (e.g., SS-PBCH-Block power)
Power control parameters
   May include any of: alpha, p0, pathloss reference RS, power per RB block, and RS power control adjustment states (e.g., closed loop factor)
Reference beam
   Index/ID of an SS/RS beam (e.g., SS, CSI-RS, TRS) that may be predefined, preconfigured or indicated to serve as a reference beam, possibly for determining any of the power offset/adjustment and RSRP/RSRQ/pathloss thresholds.
   A set of SS/RS beams (e.g., in a burst, period, pool, configuration, cell) may be associated with at least one reference beam.
   A reference beam may be configured to be located within an SS burst (e.g., one SS out of K SSs in a burst) or may be outside of a burst (e.g., separate signal outside of an SS burst).
   In exemplary embodiments, the reference beam may be transmitted with a peak transmit power.
   In exemplary embodiments, the reference beam may serve as a QCL source for the other associated beams (e.g., any of SS-a and/or SS-b beams).

The UE may receive, in configuration information, the following events, conditions and/or threshold values for selecting or using any of the SS configurations/sub-configurations, and SS beams/resources;
Measurement threshold values:
   The threshold values may correspond to any of EPRE, RSRP, RSRQ, SINR, CQI, pathloss, etc.
   For example, the UE may select and/or report on an RS (e.g., an SS-b beam), when the measurements made on an associated RS (e.g., SS-a beam) are higher/lower than an RSRP threshold.
   The threshold values may be configured/indicated on any of a per-RS/beam, per-burst, or per-config/sub-configuration basis.
Timing information:
   Start time threshold; for example, an RS resource/beam may be received if it begins no later than a start time of T1 symbols/slots/ms after the UE receives an indication associated with activation of the RS configuration to which the RS resource belongs.
   End time threshold: for example, an RS resource/beam may be received if it ends no earlier than an end time of T2 symbols/slots/ms after the UE receives an indication associated with deactivation of the RS configuration to which the RS resource belongs.
   Time window (e.g., start offset time, length): for example, the UE may use one or more RS configurations that may be accommodated within the time window for RS transmission.
Transmission reception power
   Transmit power threshold: for example, the UE may use one or more SS/RS resources (e.g., in time domain and/or frequency domain) if the receive power (e.g., total power in RS resources in a transmission instance) is less than a first power threshold value and/or greater than a second power threshold value.
   Power spectral density (PSD) threshold: for example, the UE may use one or more RS resources (e.g., in time domain and/or frequency domain) if the PSD over the RS resources is less than a first PSD threshold value and/or greater than a second PSD threshold value.
Priority
   One or more priority values may be associated with any of SS/RS configurations, SS/RS beams/resources, and RS parameters. For example, the UE may use an SS configuration, when the priority associated with the SS configuration is higher than a priority threshold value and/or lower than another priority threshold value.

### Configurations Associated With Cells in Multi-Cell Deployments for NES

In exemplary embodiments, the UE may receive information for configurations and/or sub-configurations associated with one or more cells in a multi-cell deployment. Such configuration information may include any of the following:
Configuration associated with a Coverage/Anchor Cell (Cell A):
   Cell A may provide wider coverage (e.g., One or more NES cells may be overlaid over a Cell A).
   Cell A may transmit both SS-a (e.g., long periodicity) and SS-b (e.g., short periodicity). Additional SS-a/SS-b may be transmitted by Cell A on on-demand basis.
   SS-a and/or SS-b beams may be transmitted in wide beams (e.g., when operating is NES mode) or in narrow beams (e.g., when dynamically triggered, during high load conditions).
   UE may receive UL-WUS configuration (e.g., containing PRACH resources, PUCCH/SR resources) for requesting SS/RS or SI transmission from one or more NES Cells or Cell A. Such resources in the UL-WUS configuration may be used for transmitting a UL-WUS indication to an associated other NES cell or the Cell A that provides the UL-WUS configuration.
Configuration associated with an NES cell:
   NES Cell may provide limited coverage (e.g., optimized for capacity and energy savings).
   NES Cell may transmit SS-a with long periodicity (typical) as always-on RS or as on-demand RS.
   NES Cell may transmit SS-b with short/long adaptable periodicity, where the SS-b may be a combination of always-on RS and on-demand RS.
   NES Cell may transmit sync signals, light PBCH, SS-b to support time/frequency synchronization, cell measurements, cell (re)selection, paging, initial access, etc., possibly for IDLE mode operation.
   NES Cell may transmit sync signals (e.g., SS-a/SS-b), NES-RS (e.g., OD-SSB), measurement RS (e.g., CSI-RS) to support time/frequency synchronization, RRM. RLM/BM, etc., possibly for CONNECTED mode operation.
   UE may receive the SS/RS in or out of sync master. For example, UE may receive the SSs on ARFCN channels that may be known to UE or dynamically indicated to UE.
   UE may send a UL WUS signal to NES cell for requesting SS-w/SS-b/NES-RS/SIBx, possibly in scenarios when such RS/beams are not transmitted for transmitted with long periodicity.

Throughout this disclosure, the terms “NES Cell” and “small/capacity/micro cell” may be used interchangeably. Also, the terms “Coverage cell”, “Anchor Cell” and “Cell A” may be used interchangeably

Any of the configurations, parameters and embodiments described above are applicable throughout this disclosure.

### SUMMARY

In exemplary embodiments, a UE is configured to perform CSI measurements and beam refinement/selection on a set of dynamically triggered narrow beams during a RACH procedure. The UE may perform CSI measurements and indicate a selected narrow beam when triggered by a set of conditions (e.g., RSRP of wide beams above threshold, urgent UL transmission). Configuration information/parameters for performing fast and early beam refinement, including parameters associated with SS-a/SS-b are described in greater detail below.

An exemplary method for fast and early beam refinement may entail the following:
1. UE receives a set of SS-a beams (e.g., wide beams)
   UE may perform RSRP measurements on the beams
2. UE receives cell access configuration information (e.g., in SIB), including:
   A first RACH configuration (e.g., set of PRACH preambles, RACH Occasions (ROs) in TD/FD)
   A second RACH configuration (e.g., set of PRACH/WUS preambles, ROs in TD/FD) associated with early beam refinement and one or more thresholds
      E.g., the conditions for early beam refinement and/or for selecting resources from the second RACH configuration may be any of RSRP of an SS-a beam>threshold, UL data delay< threshold, paging indication with a flag indicating urgent DL data, flag in SIB indicating non-NES mode operation on cell, etc.
   One or more SS-b beam configurations
      E.g., each configuration may include the parameters: T/F locations of SS-b beams, number of beams in a burst and number of bursts
   One or more CSI configurations for early beam refinement
      Each configuration may include the parameters: report type (e.g., semi-persistent, aperiodic), min report quantity (e.g., index of SS-b beam with highest RSRP)
3. UE selects a PRACH/WUS resource from the second RACH configuration and transmits a PRACH/WUS in the selected resource, if a condition for early beam refinement is met
   E.g., UE may select a PRACH/WUS resource associated with an SS-a beam that is above an RSRP threshold and/or with the highest RSRP
4. UE receives a RAR message in response to the PRACH/WUS transmission
   The RAR message may include one or more of:
      Index of a SS-b beam configuration
      Index of a CSI configuration
      A first UL grant (for PUSCH containing Msg3 for RRC setup request)
      A second UL grant (for PUSCH containing a CSI report on the SS-b beams)
      IDs: RACH preamble ID, Temp C-RNTI
5. UE receives a set of SS-b UE (e.g., narrow beams), e.g., based on the received index of the SS-b beam configuration
   UE may perform RSRP measurements on the set of SS-b beams in one or more bursts
   E.g. UE may monitor for the set of SS-b beams using a spatial filter associated with at least the SS-a beam used for PRACH/WUS transmission
6. UE sends a message such as RRC setup request or resume (e.g., Msg 3) in first UL grant (e.g., an UL CCCH message indicating RRC setup request or resume)
   The message may include at least the UE identity (e.g., random bit string or S-TMSI) and connection establishment or resume cause
   E.g., UE may transmit the Msg3 via the SS-a beam used for transmitting PRACH/WUS
   The message may indicate a request for beam refinement
7. UE receives contention resolution indication (e.g., Msg4)
   The contention resolution indication may include UE identity (e.g., same identity as indicated in Msg3), C-RNTI, RRC setup message, a copy of the UL CCCH message sent by the UE, and/or the second UL grant (e.g., if not included in the RAR)
8. UE sends a CSI report in resources indicated by the second UL grant
   The CSI report may include:
      index of a selected SS-b beam (e.g., beam with highest RSRP)
      RSRP of the selected SS-b beam
      C-RNTI (if Msg4 is received before second UL grant) or UE identity (if Msg4 is not received before second UL grant)
   E.g., UE may transmit the CSI report via the SS-a beam used for transmitting PRACH/WUS
9. UE receives a confirmation indication on beam refinement (e.g., in PDCCH)
   The indication may include
      index of an SS beam (e.g., same or another index of the beam indicated in CSI report. The index may be one of a SS-b beam or a SS-a beam)
      C-RNTI
   E.g. UE may monitor the PDCCH associated with the confirmation indication on the beam used for transmitting Msg3

Benefits of exemplary methods described herein may include:
Low latency for performing narrow beam refinement/selection during system/initial access
Lower UE power consumption due to performing measurements and beam selection within a shorter timeline
Incurs low energy consumption at NW due to sparse wide-beam SS transmission in combination with dense narrow-beam SS transmission on demand.

Exemplary beam refinement methods are described in greater detail below.

### Configuration Information/Parameters for Fast and Early Beam Refinement

In exemplary embodiments, a UE may be configured with (including preconfigured and/or receive configuration) information parameters associated with SS beams and associated parameters, to perform CSI measurements and beam refinement/selection during a system/cell access (e.g., RACH) procedure.

Parameters Associated with SS-a SS-b

In the examples described herein, the UE may be preconfigured with and/or receive configuration information from the network associated with the SS-a and SS-b transmitted by one or more cells. Such predefinition or configuration information may be received, entirely or in one or more parts, in any of L3/RRC signalling (e.g., broadcast/SIB or dedicated signals/messages). L2/MAC signaling (e.g., MAC CE, PDSCH) or L1/PDCCH (e.g., DCI, wake-up signalling, RAR) indications. Such information may include any combination of one or more of the following:
Set of SS/RS signals
   A UE may be configured with one or more SS signals beams (e.g., SS-a, SS-b) that may be grouped into one or more sets. Such a set may refer to any of a: burst, period, cycle, or configuration/sub-configuration.
   The parameters associated with SSs (e.g., SS-a, SS-b) may include any of:
      IDs/Index(es) of a set of SSs in a burst, number of SSs in a burst, position of SS beams in a burst (e.g., a bitmap may indicate which of the beams that are active/inactive in a burst).
      Sequences (e.g., ID/index associated with a sequence, format of a sequence, time/frequency resources), which may be used for any of sync signals and PBCH DMRS of the SS.
      Resources in any of time, frequency, spatial domains.
      Timing information, including any of: start offset, start/end symbol for set of SSs, time duration/window during which SSs are transmitted, time gap between a set of one or more SSs within and across bursts.
   In exemplary embodiments, a UE may be configured with a first set of SSs that may not be adapted (e.g., periodicity is not adapted, transmit power is constant) and a second set of SSs that may be adaptable (e.g., adaptation of periodicity, adaptation of frequency location, adaptation of transmit power).
   In exemplary embodiment a set of SSs may be associated with common properties or characteristics. Such common properties of the SSs may include any of a:
      time domain property (e.g., SSs in a set are transmitted within an SFN and/or half-frame in a SS burst, SSs in a burst are transmitted with the same periodicity),
      frequency domain property (e.g., SSs in a set are transmitted within a min-max range of subcarriers and/or resource elements in a carrier),
      spatial domain property (e.g., number of beams in a burst per frequency range, share common QCL source, common QCL type),
      power domain property (e.g., Transmit power of SSs in a set is within a max-min power range), or
      resource type (e.g., periodic, semi-persistent, aperiodic, on-demand)
   For example, when any of the property/association for at least one of the SSs in a set is changed/adapted, a similar change adaptation may apply for one or more of the other SSs in the set.
Parameters associated with one or more SS-a configurations
   UE may be predefined configured with the following parameters associated with SS-a:
      Index/ID (e.g., index per SS-a configuration, index per SS-a beam/signal)
      periodicity of SS-a (e.g., periodicity per set, per burst or per signal/beam)
      periodicity of a subset of SS-a signals containing a first PBCH transmission (e.g., periodicity per burst or per signal/beam)
      reference SFN (e.g., SFN ∩0 per SS-a configuration)
      SCS values (e.g., spacing between subcarriers of an SS-a, numerology of SS-a (per SS-a configuration))
      frequency location (e.g., location of start/center frequency of the RBs associated with SSB-a on/off sync raster)
      Cell index/ID (e.g., the PCI of the cell transmitting SS-a may be encoded/scrambled/included in any of the sequences or signals transmitted by the cell including first sync signals, first PBCH, PBCH DMRS)
      Sequence used in the RS resources associated with SS-a (e.g., m-sequence, Zadoff-Chu sequence)
      Transmit power of SS-a signals beams/resources (e.g., indexes to one of more power levels, power offset values with respect to a reference/max/min power levels)
   SS-a signals may include any of one or more sync signals (e.g., first sync signals, PSS/SSS), a MIB, PBCH (e.g., DMRS, payload). The first sync signals may be scrambled with one or more scrambling sequences. For example, the first sync signal in an SS-a received in a first time period (e.g., SFN #1) may be scrambled with a first scrambling sequence and the first sync signal in an SS-a received in a second time period (e.g., SFN #3) may be scrambled with a second scrambling sequence.
   A subset of SS-a signals may have associated system information (e.g., SIB1) that may be transmitted or received, possibly in association with the SS-a signals beams or in other associated signals channels (e.g., PDCCH/PDSCH).
   At least a subset of SS-a signals (e.g., in some time frequency locations) may include a second PBCH. The second PBCH may consist of a PBCH DMRS (e.g., sequence) and a payload. In exemplary embodiments, the payload may contain and/or may be associated with other signals/channels containing one or more SI, including any of: cell selection information, RACH configuration, UL-WUS configuration, or serving cell configuration In exemplary embodiments, for a set of SS-a signals transmitted with periodicity P3, the subset of SS-a signals that may be associated with SI ∩ a and SI ∩ b may be transmitted with periodicity P4 and P5, respectively (e.g., P4>P3, P5>P3). The second PBCH (e.g., DMRS associated with the second PBCH) may be scrambled with one or more scrambling sequences.
   UE may be configured with one or more SS-a configurations, where each. configuration may be associated with a different index/ID and properties of SS-a in any of the time domain (e.g., periodicity, start offset, reference SFN), frequency domain (e.g., location on sync raster, carrier, offset from a reference frequency location), spatial domain (e.g., number of SS-a beams of burst), or power domain (e.g., transmit power per SS-a signal/beam).
   One or more of the SS-a configurations may be associated with always-on SS-a transmissions (e.g., periodic SS-a transmissions with a fixed periodicity) and other SS-a configurations may be associated with on demand SS-a transmissions (e.g., semi-persistent or aperiodic SS-a transmissions over a time window).
Parameters associated with one or more SS-b configurations
   UE may be predefined configured with the following parameters associated with SS-b configurations (e.g., always-on SS-configuration or on-demand SS-b configuration):
      Index/ID (e.g., index per SS-b configuration, index per SS-b beam/signal)
      periodicity of SS-b (e.g., periodicity per set, per burst of per signal/beam)
      periodicity of a subset of SS-a signals containing second PBCH (e.g., periodicity per set per burst or per signal/beam)
      reference SFN (e.g., SFN #0 per SS-b configuration, SFN # x of SS-a configuration)
      SCS values (e.g., spacing between subcarriers of an SS-b, numerology of SS-b (per SS-b configuration))
      frequency location (e.g., location of start/center frequency of the RBs associated with SS-b on/off sync raster)
      Cell index/ID (e.g., the PCI of the cell transmitting SS-b may be encoded/scrambled/included in any of the sequences or signals transmitted by the cell including second/third sync signals, second PBCH, PBCH DMRS)
      Sequence used in the RS resources associated with SS-b (e.g., m-sequence Zado(T-Chu sequence)
      Transmit power of SS-b signals/beams/resources (e.g., indexes to one or more power levels, power offset with res to a reference/max/min power levels)
   SS-b may include at least a sync signal (e.g., first sync signal). The first sync signal may be different from those in SS-a (e.g., format, limited sequence length, limited resources), e.g., possibly to enable fast measurements related to synchronization. The first sync signals may be scrambled with one or more scrambling sequences. For example, the first sync signal in an SS-b received in a first time period (e.g., SFN #1) may be scrambled with a first scrambling sequence and the first sync signal in an SS-b received in a second time period (e.g., SFN #3) may be scrambled with a second scrambling sequence. Such scrambling sequences may be associated with the SFN values in which the SS-b may be transmitted, for example.
   In some examples, SS-b may correspond to low power synchronization signals (LP-SS), that may be received by the UE in a low power receiver. The UE may wake up the main radio in UE when detecting an SS-b signal with the LP receiver, for example.
   In some examples, SS-b may correspond to CSI-RS signals (e.g., RSs is associated with one or more CSI-RS sequences, possibly predefined/configured at UE).
   The parameters of an on-demand SS-b configuration may be the same or different than those of an always-on SS-b configuration. For example, a subset of parameters may be common for both always-on and on-demand SS-b configurations (e.g., frequency location) and another subset of parameters may be specific to on-demand SS-b configuration (e.g., number/positions of beams in burst, number of SS-b bursts, application delay).
   SS-b signals may not be typically transmitted in all SFNs, subframes, symbols or slots but may be transmitted in a subset of time locations (e.g., SFNs with even or odd index values).
   At least a subset of SS-b signals (e.g., in some time/frequency locations) may include a third PBCH (e.g., light PBCH). The third PBCH may consist of a PBCH DMRS (e.g., sequence) and payload. In exemplary embodiments, for a set of SS-b signals transmitted with periodicity P1, a subset of SS-b signals containing a third PBCH (e.g., PBCH DMRS and payload) may be transmitted with periodicity P2 (e.g., P2>P1). The third PBCH may be referred to herein as light PCBH and may contain less information than the first PBCH (e.g., in SS-a). The term ‘light PBCH’ is for example purposes only. Any two PBCHs transmitted or received that carry different information may be used and still be consistent with the exemplary embodiments described herein.
   UE may be configured with one or more SS-b configurations, where each configuration may be associated with different index/ID and properties in any of the time domain (e.g., periodicity, start offset, reference SFN, SCS), frequency domain (e.g., location on sync raster, carrier, offset from a reference frequency location), spatial domain (e.g., number of SS-a beams of burst), or power domain (e.g., transmit power per SS-a signal/beam).
   One or more of the SS-b configurations may be associated with always-on SS-b transmissions (e.g., periodic SS-b transmissions with a fixed periodicity) and other SS-b configurations may be associated with on demand SS-b transmissions (e.g., semi-persistent or aperiodic SS-b transmissions over a time window).
Association information between SS-a and SS-b signals may include any of the following:
   Periodicity relation
      The periodicity of SS-b transmissions may be associated with the periodicity of SS-a transmissions based on a scaling factor y (e.g., y=>1)).
      When SS-b contains or is associated with a signal (e.g., second sync signal, MIB, PBCH) or a particular SI (e.g., SIB1/SIBx), the scaling factor may be adjusted as y*i, where i may be associated with the signal or the SI. In this case, different SI may be associated with different i values, for example
      In exemplary embodiments, the periodicity of SS-b transmissions may be associated with other properties of SS-a based on different scaling factor values, including those associated with the TD/FD resources of SS-a (e.g. number of symbols, number of RBs), scrambling sequence used in the first sync signal or PBCH of SS-a (e.g., index of sequence), and time/frequency offset of SS-a (e.g., relative to a reference point). For example, the periodicity of SS-b may be determined based on the index of scrambling sequence used for scrambling the first sync signal of SS-a and an associated scaling factor value.
   Control resource set and search spaces associated with SS-a/SS-b
      UE may be configured with one or more control resource sets (CORESETs) or PDCCH monitoring configurations (e.g., PDCCH monitoring occasions) where the control indications associated with any of SS-a and SS-b may be received.
      For example, the UE may switch between a first CORESET/PDCCH monitoring configuration associated with an SS-a configuration and a second CORESET/PDCCH monitoring configuration associated with an SS-b configuration, possibly for receiving any control indications (e.g., DCI) associated with SS-a and SS-b signals.
      Periodicity of a search space (e.g., indicated by a PDCCH configuration in a MIB included in an SS-b transmission) for receiving PDCCH associated with one or more SI (e.g., a target SI) may be associated with the periodicity of the SS-a or the SS-b transmissions, e.g., based on a scaling factor z.
   Multiplexing pattern
      A multiplexing pattern may indicate that N SS-a transmissions may be followed by M SS-b transmissions, possibly within a time window or period. Different multiplexing patterns may be associated with different properties of SS-a and/or SS-b (e.g., index, periodicity, etc.).
   Timing relation
      In exemplary embodiments, the timing relation between SS-a and SS-b may indicate whether SS-a and SS-b signals are transmitted with the same or different patters. For example, the association information may indicate both SS-a and SS-b are transmitted in either even or odd numbered SFNs. In this case, a subset of the even/odd SFNs that contain SS-a may also contain SS-b, for example.
      A timing relation between SS-a and SS-b may be associated with a time offset. The time offset for SS-b relative to SS-a or a reference time point (e.g., in units of SFNs, subframes, symbols, ms) may be associated with properties of SS-a based on different scaling factor values, including those associated with the periodicity of SS-a, TD/FD resources of SS-a (e.g., number of symbols, number of RBs), scrambling code/sequence used in the first sync signal or first PBCH of SS-a (e.g., index of sequence), and time/frequency offset of SS-a (e.g., relative to a reference point).
      For example, the time offset of an SS-b signal (relative to an SS-a signal) may be determined based on the periodicity of SS-a and a time offset scaling value.
      For example, the time offset of an SS-b signal (relative to an SS-a signal) may be determined based on the scrambling code/sequence used in the PBCH of SS-a. The scrambling code in PBCH of SS-a may indicate the number of time periods (e.g., SENs) to the nearest SS-b from the
      In exemplary embodiments, timing relation information may be provided as a time offset/gap between the last symbol/slot of an SS-a signal/beam in a burst and the first symbol/slot of the first of N SS-b beams in a burst. For example, the timing of an SS-a signal/beam (e.g., last symbol/slot of an SS-a beam in a burst of an SS-a configuration) may be T1 and the timing of the SS-b beam (e.g., first symbol/slot of the first SS-b beam in a burst of an SS-b configuration) may be T2−T1+time offset.
      In exemplary embodiments, the set of SS-a beams in a burst and another set of SS-h beams in a burst may be transmitted within a window duration, which may be the same or related based on a scaling factor. For example, the time duration for an SS-b burst may be related by i*D, where D is the duration for an SS-a burst and i is a scaling factor (e.g., i=1, 1.5, . . . ).
   Frequency relation
      A frequency relation between SS-a and SS-b may be associated with a frequency offset. Frequency offset for SS-b relative to SS-a or a reference frequency location point (e.g., in units of subcarriers, carriers, resource elements, resource blocks, Hz) may be associated with properties of SS-a based on different scaling factor values, including those associated with the periodicity of SS-a, TD/FD resources of SS-a (e.g., number of symbols, number of RBs), scrambling sequence used in the first sync signal or PBCH of SS-a (e.g., index of sequence), and time/frequency offset of SS-a (e.g., relative to a reference point).
      For example, the frequence offset of an SS-b signal (relative to an SS-a signal) may be determined based on the periodicity of SS-a and a frequency offset scaling value.
      In some examples, the resources of SS-a and SS-b may be located in the same or different bandwidth parts (BWPs) and carriers. When SS-b is located in the same or a different BWP and/or carrier than SS-a, the location information (e.g., absolute or relative location in terms of offset) may be indicated in any of the MIB, PBCH, or SIB received in association with SS-a.
   Spatial relation
      Spatial relation for SS-b beams relative to SS-a beams (e.g., in terms of number of beams per burst) may be associated with properties of SS-a based on:
         scaling factor values, including those associated with the number of SS-a beams in a burst, the periodicity of SS-a, TD/FD resources of SS-a (e.g., number of symbols, number of RBs), SCS of SS-a, scrambling sequence used in the first sync signal or PBCH of SS-a (e.g., index of sequence), and time/frequency offset of SS-a (e.g., relative to a reference point).
      For example, the number of SS-b beams in a burst may be determined based on the number of SS-a beams in a burst and a beam number scaling factor b (e.g., b>=1).
      In exemplary embodiments, one (wide beamwidth) SS-a beam may be associated with N (narrow beamwidth) SS-b beams (e.g., N may be equal to 1 or greater than 1).
      The QCL information between the beams in SS-a and SS-b may be provided as a mapping relation between an ID/index of SS-a beams and ID/indexes of SS-b beams.
         For example, an SS-a beam with index i may be associated with a set of SS-b beams with indexes {a, b, c, d, e}.
         In this case, the set of SS-b beams {a, b, c, d, e} may fall within the beamwidth or coverage of SS-a beam i and/or may be transmitted from the same/similar set of antenna elements/ports/panels as the cell.
         The UE may use the same/similar spatial relation (e.g., spatial receive filter) for receiving both SS-a beam i and any beams within the set of SS-b beams {a, b, c, d, e}.
Association information between SS-a and SS-b beams:
   Association between a set of wide beams in SS-a and narrow beams in SS-b
      For example, the SS-a wide beam index {SS-a #1} may be associated with an SS-b narrow beam indexes set consisting of {SS-b #0, SS-b #1, SS-b #2 SS-b #3}
   Periodicity of a set of SS-b beams (e.g., in a burst of one or more beams) may be associated with the periodicity of a set of SS-a beams (e.g., in a burst of one or more beams) based on a scaling factor
      For example, the periodicity of the SS-b beam set {SS-b #0, SS-b #1, SS-b #2, SS-b #3} may be associated with the periodicity of an SS-a wide beam {SS-a #1} based on a sealing factor y1.
RACH configurations
   The UE may be configured (e.g., preconfigured or via SIB, RRC, L2/L1 signaling) with one or more RACH configurations consisting of resources in any of time, frequency, spatial, and sequence (e.g., preamble) domains for performing RACH transmissions (e.g., during initial access, beam refinement, cell (re)selection, cell switch, cell wake-up, mobility, etc.).
   Such RACH configurations may be associated with the one or more SS-a and/or SS-b beams. For example, SS-a with index i may be associated with n1 preambles (e.g., per RO), n2 RACH occasions (ROs) in the time domain (TD) and n3 ROs in the frequency domain (FD). Similarly, SS-b with index k may be associated with m1 preambles (e.g., per RO), m2 ROs in the TD and m3 ROs in the FD. In exemplary embodiments, the association relation between SS-a/SS-b and RACH resources (e.g., in terms of SS-to-RO mapping) may be different for CSI-based RACH than for non-CSI based RACH.
   Such RACH configurations may be associated with one or more UL-WUS configurations, which may be used to transmit a request indication for any of an SSBs, SS-a, SS-b, or SIB (e.g., SIB1). The resources in the UL-WUS configurations may be associated with the same resources (e.g., fully or partially overlap) or different resources (e.g., no overlap) than those in RACH configurations. For example, such resources may be the same or different in terms of PRACH configuration index, preambles (e.g., formats, length, sequences), transmit power parameters, and/or ROs.
   At least a subset of such RACH resources may be associated with indicating UE capability (e.g., for performing beam refinement, CSI measurements) and/or for requesting any of SS-b beams, CSI configurations, and resources for sending CSI reports. In exemplary embodiments, a subset of the RACH resources for CSI-based RACH may be associated with the same RACH configurations used for non-CSI-based RACH (e.g., 5G initial access). When associated with the same RACH configuration, the CSI-based RACH resources and RACH resources for non-CSI-based RACH may fully or partially overlap (e.g., same preamble or RO may be used for both purposes). When associated with different RACH configurations, the RACH resources for different purposes may be separate.
   In exemplary embodiments, a first set of RACH resources (e.g., set or preambles, ROs in ID/FD) may be associated with SS-a beams and a second set of RACH resources may be associated with SS-b beams. In this case, the first and second set of RACH resources may or may not overlap in any of time, frequency, spatial, or preamble domain.
   The parameters of a RACH configuration (e.g., associated with SS-a and/or SS-b) for CSI-based RACH that may be configured in the UE may include any of the following:
      PRACH configuration index
         Time domain location (e.g., number of subframes, slots, and symbols) where PRACH may be transmitted.
         Preamble format (e.g., short or long preambles)
         In exemplary embodiments, the ROs in TD associated with an SS-a beam may range from symbol 5 to 8 and the ROs in TD associated with an SS-b beam may range from symbols 1 to 4.
      Number of PRACH preambles (e.g., per CBRA configuration, per CFRA configuration)
         In exemplary embodiments, the number of preambles for CSI-based RACH (for CBRA/CFRA) may be higher/lower/same than those for non-CSI-based RACH.
      Frequency domain configuration
         msg1-FrequencyStart: starting frequency offset (e.g., in number of PRBs) for PRACH resources relative to the uplink bandwidth part (BWP).
         msg1-FDM: number of frequency-multiplexed PRACH occasions (e.g., 1, 2, 4, or 8 FDMed) at the same time domain location
         In exemplary embodiments, the ROs in FD associated with an SS-a beam may range from msg1-FDM 1 to 4 and the ROs in FD associated with an SS-b beam may range from msg1-FDM 5 to 8.
         In other examples, the ROs in FD associated with CSI-based RACH may range from msg1-FDM 1 to 2 and the ROs in FD associated with non-CSI based RACH beam may range from msg1-FDM 3 to 4.
      SSB-to-RO Mapping (e.g., ssb-perRACH-OccasionAndCB-PreamblesPerSSB)
         ssb-perRACH-Occasion: number of SS-a and/or SS-b associated with one PRACH occasion (e.g., ⅛, ¼, 1, 2, 4, 8). In exemplary embodiments, the SS-to-RO mapping for SS-a may be the same (fully or partially overlap) or different than those for SS-b (no overlap).
         CB-PreamblesPerSSB: number of contention-based preambles per SS-a and/or SS-b. In exemplary embodiments, the number of preambles for SS-a may be the same or different than for SS-b.
      Power Control parameters
         preambleReceivedTargetPower: tr power at the gNB (e.g., −120 to −90 dBm).
         powerRampingStep: power increase steps (e.g., 2, 4, 6 dB) for preamble retransmissions if no RAR is received. In exemplary embodiments, the power increase steps for CSI-based RACH may be higher/lower than for non-CSI-based RACH.
         preambleInitialReceivedTargetPower: initial preamble power setting.
      Random Access Response (BAR) Window
         Ra-ResponseWindow; time window the UE expects a RAR message (e.g., 20 ms). In exemplary embodiments, the RAR window for CSI-based RACH may be the same or different than for the non-CSI based RAR. For example, the CSI-based RAR may be longer/shorter/same than the non CSI-based RACH.
         The CORESETESS where the UE may monitor for RAR associated with CSI-bases RACH may be the same or different than that of non-CSI-based RACH.
      Contention Resolution Timer
         ra-ContentionResolutionTimer (e.g., 8 to 64 subframes): duration for the UE to wait for Msg4 (contention resolution).
      Maximum Number of Preamble Transmissions
         preambleTransMax: In exemplary embodiments, the maximum number of preamble transmissions for CSI-based RACH may be higher/lower than for non-CSI-based RACH.
      RACH Backoff Indicato:
         In exemplary embodiments, the backoff indicator (associated with the delay before retransmitting a preamble after failure) for CSI-based RACH may be shorter/longer than the backoff for non-CSI-based RACH.
   RAR (e.g., PRACH/WUS response) monitoring configuration
      The UE may be predefined/configured with one or more resources in any of time, frequency, spatial, and code domains for receiving one or more RAR indications from the NW, possibly upon transmitting a PRACH/UL-WUS indication.
      Such resources may be associated with a CORESET and/or a search space (SS), which may be associated with an initial bandwidth part, which may be monitored by the UE with a certain configured periodicity and/or a duration possibly upon transmitting PRACH. In exemplary embodiments. such resources for RAR for CSI-based RACH may be the same or different than the resources for the RAR for non-CSI-based RACH.
      Such CORESET and/or SS may be associated with CORESET0 and/or SS0 (common search space), which may be used for receiving a common PDCCH from the network.
      Such CORESET and/or SS may be associated with one or more multiplexing patterns which may indicate how the monitoring resources in which RAR may be received may be multiplexed with SS-a signals (e.g., in TD/FD).
      The UE may be configured with one or more parameters associated with RAR monitoring configuration including index (e.g., index of WUS monitoring configuration), periodicity, RAR window duration (e.g., start/end time), time/frequency resource offset (e.g., with respect to a reference point in time/frequency), and start offset (e.g., with respect to a reference time point such as start of window, end of window, PRACH/UL-WUS transmission time).
   Conditions for using a RACH configuration associated with CSI-based RACH (e.g., for requesting initiating SS-b, request CSI measurements or beam refinement during RACH) may include any of the following:
      RSRP/RSRP/energy of an SS-a beam is greater than, less than, or equal to one or more thresholds
      RSRP/RSRQ/energy change of an SS-b beam (across one or more bursts) is greater/less than equal to one or more thresholds
      Time-gap (e.g., in terms of SFNs, subframes, slots, symbols, ms) to a nearest SS-b beam (e.g., in always-on or on-demand SS-b configuration) is greater than a threshold.
      Frequency location of SS-b signals is greater than a threshold and/or less than a threshold
      No other on-demand SS-b transmissions are received or expected to be received in one or more time frequency/spatial locations and/or within a duration/window
      No other PRACH/UL-WUS response indication (e.g., RAR message, PDCCH) is received in the associated CORESET within a monitoring duration window, possibly in a PRACH/UL-WUS response monitoring config/resources.
      Delay (e.g., PDB, remaining time) of an UL PDU is greater than, less than, or equal to one or more thresholds
      Paging indication received indicating urgent DL data (e.g., urgency flag, low PDB, low remaining time)
      SIB/PDCCH reception indicating non-NES mode operation on cell (e.g., cell DTX/DRX mode disabled on cell. SSB/SS adaptation disabled on cell, spatial domain adaptation disabled on cell)
CSI configurations
   The UE may be configured (e.g., preconfigured or via SIB, RRC, L2/L1 signaling) with one or more CSI configurations consisting of resources in any of time, frequency, spatial, power, and or sequence domains for performing CSI measurements (e.g., during initial access, beam management, beam refinement, cell (re)selection, cell switch, cell wake-up, mobility, etc.).
   Such CSI configurations may be associated with the one or more SS-a and/or SS-b beams. For example, SS-a with index j may be associated with CSI configurations, including any of a set k1 of CSI resource configurations and a set k2 of CSI report configurations.
   Similarly, SS-b with index k may be associated with CSI configurations, including any of a set p1 of CSI resource configurations and a set p2 of CSI report configurations
   Such CSI configurations may be associated with one or more UL-WUS configurations, which may be used to transmit a request indication for any of an SSBs, SS-a beam, SS-b beam or SIB (e.g., SIB1).
   The parameters of a CSI configuration for CSI-based RACH, that may be configured in a UE, may include any of the one or more of the following:
      CSI resource configuration (e.g., comprising of any of SS-a, SS-b, CSI-RS sources for channel measurements)
         CSI-ResourceConfig: ID/Index of a CSI resource configuration
         Types of resources (e.g., SS-a SS-b, SS, SG SSB, CSI-RS, TRS)
         Resource Sets: ID/Index of a set/group of CSI resources (e.g., set of SS-b indexes)
         Resource Mapping: resources in any of time, frequency, spatial, power, or sequence domain associated with CSI resources (e.g., SS-b resources)
      CSI report configuration
         CSI-ReportConfig: ID/Index of a CSI resource config
         In exemplary embodiments, a CSI report configuration may be associated with at least one CSI resource configuration (e.g., index of a set of SS-b beams/resources
         In exemplary embodiments, a CSI report configuration may consist of one or more sub-configurations, where each sub-configuration may consist of a set of parameters that may be common to all sub-configurations (e.g., report type) and/or specific to each sub-configuration (e.g., CSI resource configuration).
      Report quantity
         cri-RI-PMI-CQI: CSI-RS Resource Indicator (CRI) (e.g., index of the best CSI-RS resource), Rank Indicator (RI), Precoding Matrix Indicator (PMI), and Channel Quality Indicator (CQI).
         cri-RI-CQI: CRI, RI, and CQI (no PMI, e.g., for Type II codebooks or non-precoded CSI-RS).
         cri-RI-LI-PMI-CQI: Includes L1 for multi-layer transmission.
         ssb-Index-CQI: SSB index (e.g., index of the best SS-a/SS-b beam) and CQI for beam management.
         cri-RSRP: RSRP associated with a CRI
         ssb-Index-RSRP: RSRP associated with a SSBRI
         none: no report (used for triggering measurements without CSI feedback).
      Report Configuration Type
         Periodic: UE may send CSI reports at regular intervals using PUCCH resources.
         Semi-Persistent on PUCCH: activated/deactivated via MAC Control Element (CE) for sending CSI reports in semi-persistent manner using PUCCH resources.
         Semi-Persistent on PUSCH: triggered via DCI for sending CSI reports in semi-persistent manner on PUSCH resources.
         Aperiodic: one-time report triggered by DCI for sending a CSI report on PUSCH resources.
      Report Frequency Configuration
         Wideband Reporting: single CSI value for the entire bandwidth.
         Subband Reporting: separate CSI values for each subband (e.g., subband size depends on BWP size).
      Time Restriction for Channel Measurements
         timeRestrictionForChannelMeasurements: if enabled, UE may use only the latest CSI resource (e.g., SS-a/SS-b beams) for measurements; otherwise, the UE may average measurements over multiple instances (e.g., SS-a/SS-b beams over multiple bursts).
      Codebook Configuration
         Type I Codebook: UE may be configured for single-panel or multi-panel MIMO with lower feedback overhead (e.g., Type I-SinglePanel, Type I-MultiPanel).
         Type II Codebook: UE may be configured for high-resolution CSI with detailed spatial information (e.g., Type II, Type II-PortSelection).
      PUCCH/PUSCH Resource Configuration
         PUCCH-Resources: For periodic or semi-persistent reporting on PUCCH. For example, PUCCH resources may be used for reporting CSI of the beams associated with an always-on SS-b configuration, or an on-demand semi-persistent SS-b configuration.
         PUSCH Resources: For aperiodic or semi-persistent reporting, allocated via DCI. For example, PUSCH resources may be used for reporting CSI of the beams associated with an on-demand semi-persistent SS-b configuration or an on-demand aperiodic SS-b configuration.
         reportSlotConfig: Indicates the periodicity and slot/symbol offset for periodic/semi-persistent reports.
      Group-Based Beam Reporting
         If enabled, the UE may report multiple SS-a/SS-b indices and their RSRP values.
         If disabled, the UE may report only the best beam (e.g., the SS-a/SS-b beam with highest RSRP).
      CSI Aperiodic Trigger State
         CSI-AperiodicTriggerStateList: Maps trigger states to one or more CSI-ReportConfiguration IDs/indexes. UE may be triggered for a trigger state via DCI, for example, containing a CSI request field.
CORESET/SS configuration
   The UE may be predefined/configured with one or more resources in any of time, frequency, spatial, and/or code domains for receiving any of group common, cell-common, or UE-dedicated indications from the NW, possibly in PDCCH.
   Such resources may be associated with a CORESET and/or a search space (SS), which may be associated with an initial bandwidth part, which may be monitored by the UE with a certain configured periodicity and/or a duration.
   Such CORESET and/or SS may be associated with CORESET0 and/or SS0 (common search space), which may be used for receiving a common PDCCH from the network.
   Such CORESET and/or SS may be associated with one or more multiplexing patterns which may indicate how the monitoring resources in which a PDCCH may be received may be multiplexed with SS-a signals (e.g., in TD/FD).
   The UE may be configured with one or more parameters associated with CORESET/SS configuration including index (e.g., index of WUS monitoring configuration), periodicity, and time frequency resource offset (e.g., with respect to a reference point in time frequency.
Application time/delay
   The UE may be configured with one or more application time/delay values, which may indicate a time duration starting with the time instance (e.g., symbol/slot) from the reception of an indication indicating the start/triggering of the SS-a/SS-b signals/beams to the time instance when the SS-a/SS-b signals/beams are actually transmitted or received.
   In exemplary embodiments, the application time for SS-a beams/bursts may be the same or different than those of SS-b beams/bursts.
Validity information associated RS configurations
   The UE may be configured with validity information associated with the SS-a and SS-b configurations. Such validity information may be associated with any of time and location attributes.
   For example, a time validity may indicate the time duration (e.g., in terms of SFNs, symbols, slots) during which any of the SS-a and SS-b configurations may be assumed to be valid. After the end/expiry of the time duration, the UE may assume the SSs associated with the SS-a and SS-b configurations are no longer available/valid.
   In another example, a location validity may indicate the coverage area or location possibly that associated with UE location and/or cell ID, in which any of the SS-a and SS-b configurations may be assumed to be valid. Outside of the location validity, the UE may assume that the SSs associated with the SS-a and SS-b configurations are no longer available/valid, for example.
NES states/modes
   The UE may be configured with association information between NES states/modes and the corresponding SS-a and SS-b configurations. For example, when configured with cell DTX configuration, consisting of a set of periodically occurring active and non-active periods, the UE may assume SS-a signals may be available during the cell DTX non-active periods or when cell DTX is deactivated, and the SS-b signals may be available only during the cell DTX active periods. In another example, the UE may assume SS-a signals may be available regardless of cell DTX periods and SS-b signals may be available only during cell DTX active periods.
   Alternatively, the SS-a signals may be available in a first group of symbols slots/periods associated with cell DTX and the SS-b may be available in a second group of symbols/slots/periods associated with cell DTX, for example.

### Fast and Early Beam Refinement on SS-a/SS-b Beams

In exemplary embodiments, a UE may determine to perform CSI measurements and beam refinement/selection during a cell access (e.g., RACH) procedure. Such CSI measurements and beam refinement may be performed on a set of dynamically triggered SS-b beams (e.g., narrow beams). Prior to performing RACH, the UE may receive one or more SS-a beams (e.g., wide beams) from such cell. The UE may not receive the always-on SS-a beams or may receive SS-a beams with long periodicity from such cell, possibly operating in an energy savings mode. When SS-b beams are triggered, the UE may perform CSI measurements and indicate a selected narrow beam, possibly when a set of conditions (e.g., thresholds) described herein are met.

The numbers in the following headings correspond to the numbers of the operations set forth in the Summary above.

### (1) UE Receives SS-a Beams

In exemplary embodiments described herein, the UE may receive one or more beams of SS-a from a cell of a wireless network. Such SS-a beams may be associated with an active SS-a configuration. Such SS-a beams may be received by the UE during any of the following: power on, when supporting any functions associated with IDLE mode (e.g., cell (re)selection, synchronization, SI update, paging), and when supporting functions associated with CONNECTED mode (e.g., L1/L3 measurements, RLM, BM).

In typical scenarios, the UE may receive SS-a beams before SS-b beams. Such scenarios may be applicable during any of the following: SS-a beams may be transmitted or received more frequently than SS-b beams (e.g., periodicity of an always-on SS-b is longer than that of SS-a), transmission of on-demand SS-b beams may be requested by the UE (e.g., during RACH). transmission of on-demand SS-b beams may be requested by another UE and UE receives an indication of the upcoming SS-b transmission. Another scenario is when SS-a may be in the frequency domain on the sync master carriers or initial/start-up carriers (e.g., perched carriers). which may be preconfigured/predefined in the UE. The SS-b may be located on a different carrier (e.g., anchor carrier) that may not be known to the UE in advance. In some scenarios, where both SS-a and SS-b may be located on the same earners, the UE may receive at least one transmission of SS-b, possibly before receiving SS-a. In this case, the UE may achieve synchronization with one or more SS-b beams without SS-a beams, and perform other idle mode functions (e.g., cell selection, initial access) based on the MIB/PBCH/SI received in association with SS-b. Otherwise, the UE may first receive SS-a beams (e.g., for synchronization and locating/requesting SS-b) before receiving SS-b beams.

The SS-a beams received by a UE may contain at least a first sync signal and a first PBCH. The first PBCH may consist of PBCH DMRS and payload (e.g., N bits). The UE may achieve synchronization with a cell transmitting SS-a beams based on detection/reception of the first sync signals in one or more SS-a beams.

The first PBCH in an SS-a beam (e.g., first PBCH payload) may indicate any of the following parameters. Alternatively, any of the following parameters, including a subset, may be indicated explicitly or implicitly via DL control indications (e.g., L1/PDCCH or L2/MAC CE), RAR message, Msg4, paging messages, SIBx or any system/cell access messages:
SFN
   e.g., n bits for indicating the SFN value where SS-a is located
indication of SS-b configuration
   Such indication (e.g., indicating IDs indexes) may be associated with any of the one of more of predefined/preconfigured SS-a configurations that may be active
   For example, different SS-a configurations may be associated with different sets of parameters (e.g., periodicity, number of beams in burst, center frequency location, etc.)
indication of an always-on SS-b configuration
   Such indication (e.g., indicating IDs/indexes) may be associated with any of the one or more predefined/preconfigured SS-b configurations, e.g., indicates the always-on SS-b configurations that may be associated with the SS-a.
   For example, different SS-b configurations may be associated with different sets of parameters (e.g., periodicity, number of beams in burst, beamwidth, etc.).
   The indication may indicate at least one of the preconfigured SS-b configurations that may be active, for example (e.g., bit value ‘1’ indicates activated and bit value ‘0’ indicates deactivated).
association between SS-a and SS-b configuration
   e.g., indicates an index/ID of the association between SS-a and SS-b
scaling factor value for the periodicity of an SS-b
   e.g., scaling factor may indicate that the periodicity of SS-b is some multiple (e.g., 2×) of the periodicity of SS-a
scaling factor value for the periodicity of the SS-a for receiving PDCCH/PDSCH associated with SIB (e.g., SIB1)
   e.g., a scaling factor value may indicate that the periodicity for receiving PDCCH/PDSCH associated with a SIB is some multiple (e.g., 4×) of the reference periodicity which may be that of SS-a or SS-b.
scaling factor value for the periodicity of SS-b narrow beams associated with the periodicity of SS-a wide beams
   e.g., scaling factor may indicate that the periodicity of SS-b narrow beams is some multiple (e.g., 2×) of the periodicity of an SS-a wide beam
   e.g., 2 bits may be used per SS-a wide beam for indicating one of 4 possible scaling factor values for the periodicity of SS-b narrow beams
index of an SS-b narrow beam (e.g., indicates the SS-b beam index which may be associated with an SS-b configuration)
index of an SS-b configuration (e.g., indicates the SS-b configuration associated with the SS-a configuration)
association between SS-a wide beam and SS-b narrow beams
   e.g., indicates an index/ID of the association between SS-a and SS-b beams
indication of CORESET/search space (SS) configuration
   May indicate an index/ID to a predefined/preconfigured configuration/resources associated with CORESET and or search space (e.g., CORESET0 or SS0).
   Such CORESET/SS configuration may be associated with a common set of resources (e.g., in any of time, frequency, spatial, and code domains) which the UE may monitor for receiving any or group-common, cell-common, or UE-dedicated indications (e.g., DCI), possibly in PDCCH.
   For example, the CORESET/SS information may be used for receiving PDCCH. associated with any of the following: SIB, RAR message, CSI configuration indications, resources for CSI reporting, Msg4, and any system/cell access messages.
   Such CORESET/SS configuration may be associated with one or more properties of SS-a (e.g., index, periodicity, symbol duration, scrambling code in first PBCH), which may be used by the UE for determining the corresponding CORESET/SS configuration.
indication of priority
   May indicate the priority value associated with one or more SS-b configurations (e.g., always-on and on-demand SS-b configurations).
   In exemplary embodiments, when any of the SS-b beams associated with different SS-b configurations overlap in any of the time, frequency, or spatial domains, the UE may use the indicated priority value for determining which of the SS-b beams to be selected and/or used, e.g., for measurements, cell (re)selection initial access, etc. In this case, the UE may select the SS-b signals associated with the SS-b configuration with the highest priority, for example.
time location of SS-b
   E.g., may indicate the absolute time location (e.g., SFN) or a relative time location of an SS-b (e.g., next/nearest SS-b signal/beams) in terms of a time offset relative to the time location of SS-a or a reference time point (e.g., PDCCH, RAR message, start/end of RAR window). Such time offset may be indicated in units of SFNs, subframes, slots, symbols, and/or ms.
   In exemplary embodiments, the time offset for SS-b (e.g., time period, possibly in terms of SFNs, when SS-b is transmitted relative to SS-a or reference time point) may be indicated by a scrambling code/sequence in the first PBCH of SS-a, where the scrambling code/sequence may be associated with the time offset value
frequency location of SS-b
   E.g., may indicate the absolute frequency location (e.g., carrier) or a relative frequency location of an SS-b (e.g., next/nearest SS-b signal) in terms of a frequency offset relative to the frequency location of SS-a (e.g., center frequency) or a reference time point (e.g., point A). Such frequency offset may be indicated in units of subcarriers, carriers, resource elements, or resource blocks.
transmit power parameters
   E.g., may indicate at least one of several predefined/preconfigured transmit power values used for SS-a and/or SS-b signals. Such transmit power may be used by the UE for pathloss estimation and/or for determining the transmit power for any UL transmissions (e.g., PRACH).
   In exemplary embodiments, the transmit power for SS-b may be indicated as an offset or scaling value that may be applied to the transmit power of SS-a or a reference power value (e.g., max transmit power). In this case, the UE may determine the transmit power of SS-based on the transmit power of SS-a and the corresponding power offset value, for example.
   Other parameters that may be indicated in the first PBCH may include p0 and alpha value, which may be associated with power control.
indication on activation/deactivation of SS-b configurations
   Such indication (e.g., indicating IDs/indexes) may be associated with any of the one of more SS-b configurations or SS-b beams (e.g., in a burst). For example, different SS-b configurations may be associated with different sets of parameters (e.g., periodicity, number of beams in burst, etc.) The indication may indicate at least one of the preconfigured SS-b configurations that may be active/non-active, for example.
   Such indication may be associated with any of periodic, semi-persistent, aperiodic or on-demand SS-b configurations.
   Such indication on (de)activation of SS-b configurations may be received in a bitmap format, possibly with a certain configured length corresponding to the number of configured SS-b configurations, where bit value ‘1’ in the bitmap may indicate the activation of an SS-b configuration and bit value ‘0’ may indicate deactivation of an SS-b configuration.
   Such indication on (de)activation of SS-b beams may be received in a bitmap format, possibly with a certain configured length corresponding to the number of configured SS-b beams (e.g., in a burst), where bit value ‘1’ in the bitmap may indicate the activation of an SS-b beam and bit value ‘0’ may indicate deactivation of an SS-b beam.
   When receiving an activation indication, the UE may assume the SS-b signals/beams associated with the SS-b configurations are usable. The UE may assume the information resources in the activated SS-b configurations may be used immediately, after a certain application time (e.g., configured/indicated) or after receiving another triggering indication, for example.
   When receiving a deactivation indication, the UE may assume the information resources in the deactivated SS-b configurations may be unused immediately, or after a certain application time (e.g., configured/indicated), for example.
   In exemplary embodiments, the indication may include information on new or updated parameters associated with the SS-b configurations. For example, the indication may indicate a set of new parameters (e.g., in time, frequency, spatial domain) for one or more SS-b configurations.
Signalling indicating the activation deactivation of NES adaptations/states
   Such an indication may indicate the NES adaptation schemes (e.g., IDs/indexes) such as SD/PD adaptations and cell DTX/DRX, based on which the UE may determine (e.g., identify) the associated SS-configurations, for example.
   In exemplary embodiments, the indication may include timing information (e.g., in terms of absolute time symbols slots/ms or relative time with respect to reference symbols/slots/ms) indicating when the NES adaptation is expected to start/end.

The UE may be preconfigured with one or more sets of parameters/indications that may be included in different first PBCH formats or in PDCCH (e.g., associated with RAR or SIB). For example, a first set of parameters (e.g., {time/frequency location of SS-b}) may be included in one first PBCH format and second set of parameters (e.g., (CSI configuration may be included in another first PBCH format or in PDCCH. For example, the association between the sets of parameters and the signaling (e.g., PBCH formats, PDCCH) may be preconfigured and the corresponding parameter values may be indicated in the signaling.

For minimizing the payload size of the first PBCH, only a subset of the parameters in the first PBCH may be provided explicitly. The remaining subset of parameters may be received in PDCCH/PDSCH or derived by UE implicitly based on a combination of a limited number of bits in the first PBCH and other parameters that may be predefined/preconfigured (e.g., in the association information) or in PDCCH/PDSCH.

In exemplary embodiments, the UE may not receive the absolute SEN value of SS-a in the first PBCH or PDCCH (e.g., associated with RAR or SIB) but the SFN of SS-a (e.g., SFN # x) may be determined and/or used in relative terms for determining the candidate time locations of SS-b (e.g., SEN of SS-b=SFN # x+time offset). Alternatively, the SFN of SS-a may be determined based on one or more bits/signals/sequences included with those associated with SS-a such as the first sync signal and first PCBH-DMRS. Alternatively, the SFN of SS-a may be determined based on the scrambling sequence (index) that may be used for scrambling any of the first sync signal, first PBCH-DMRS and the first PBCH payload.

In exemplary embodiments, the UE may not receive the scaling factor for periodicity and may determine the periodicity of SS-b relative to the periodicity of SS-a based on the predefined scaling factor (e.g., periodicity of SS-b is 4× periodicity of SS-a) The UE may determine the periodicity of SS-b or the index of a corresponding SSB-b configuration or beam based on the SS-a periodicity (e.g., by monitoring SS-a signals in at least 2 occasions/periods) and the association information between the SS-a periodicity and the SS-b periodicity or the SS-b config/beam index.

In exemplary embodiments, the UE may determine the candidate time locations of SS-b (e.g., in terms of SFNs) within a window based on a detection of a bit in the first PBCH of SS-a in one or more SFNs where SS-a beams may be received and the predefined association information, indicating the presence of the bit in first PBCH and the presence of SS-b beams within the window. For example, when the first PBCH of SS-a received in one or more SFNs contains a bit (e.g., in a bitfield), the UE may assume that at least one SS-b beam may be transmitted in one or more of the SFNs (in a window).

A similar approach may be applied for determining the time offset and/or frequency offset of SS-b based on some bits in the first PBCH or PDCCH (e.g., associated with RAR or SIB) and the association information between properties of SS-a and SS-b. For example, the UE may use one or more bits indicated in the first PBCH (in a bitfield) or PDCCH and derive the time/frequency offset based on the bit value and the association between periodicity of SS-a and the bit value.

The UE is configured to perform measurements on the SS-a beams. In the examples described herein, the UE may be preconfigured or it may receive an indication on a first measurement configuration, where the measurement configuration may be associated with an SS-a configuration.

When in CONNECTED mode, such indication may be received in any of L3/RRC, L2 or L1/DCI signaling For a UE in IDLE mode, such indication may be received in SIBx, in a paging message (e.g., L1/DCI indication, paging early indication), initial access messages (e.g., Msg2, MsgB, Msg4), and WUS response message. Such indication received by UE may indicate a request to perform measurements on SS-a signals/beams, for example. Such indication may include the IDs/indexes of one or more cells, ID/index of at least one SS-a configuration and possibly one or more RSRP threshold values.

The UE may perform measurements on the SS-a signals/beams received from the indicated cells. Such measurements, possibly on the wide beam SS-a signals, may be associated with any of L3, L2 and/or L1 measurements. When performing measurements on SS-a received from one or more cells, the UE may apply parameters associated with different spatial receive filters, for example. The UE may be configured to perform measurements on any of the signals/channels associated with the one or more SS-b a, including first sync signals and DMRS of PBCH.

Prom a set of one or more SS-a beams received by the UE, the UE may perform RSRP/RSRQ measurements (e.g., L1/L3 measurements) on the received beams and may select an SS-a wide beam based on the measurements. For example, the UE may select an SS-a wide beam based on the beam that has the highest RSRP. Daring measurements, for example, if the UE detects both SS-b and SS-a beams (from the same or different cells), the UE may prioritize measurements on the SS-a signal, beams, possibly upon receiving the measurement configuration. In exemplary embodiments, the UE may identify one or more preferred SS-a beams in the SS-a configuration based on the measurements, where the preferred SS-a beams may be those with RSRP above a threshold value.

The UE may send the measurement report or indication, possibly to the cell from which the UE received the first measurement configuration (e.g., serving cell or camping cell). The measurement report may include any of the IDs indexes of cells on which measurements are made, RSRP measurements of the sync signals/DMRS in SS-a beams and IDs/indexes of one or more preferred SS-a beams. When in CONNECTED mode, the UE may send the report/indication in any of RRC signaling, L2 (e.g., UL MAC CE) or L1 (e.g., UCI, PUCCH, PUSCH) signaling. When in IDLE mode, UE may send the report indication, at least in part in any of system/cell access mess es (e.g., Msg1, MsgA, Msg3, Msg5), UL WUS resource/signal and common set of resources possibly accessed on contention basis. Such measurement reports/indication may indicate the suitability of cell switching or cell selection to another cell.

### (2) UE Receives Access Information for Initiating CSI-Based RACH

In exemplary embodiments described herein, the UE may receive system/cell access information for performing CSI measurements and beam refinement during RACH. Such system/cell access information (e.g., configurations, parameters described above) may be received in SIB (e.g., SIB1, a new SIB), possibly in PDCCH/DCI and in an associated PDSCH carrying the SIB. Such PDCCH may be received in predefined CORESET/SS or in CORESET0/SS0 (e.g. indicated in the MIB/PBCH of an SS-a beam). Such PDCCH may be received in a PDCCH monitoring occasion associated with one or more SS-a beams. For example, the UE may monitor the PDCCH monitoring occasions associated with at least on the best SS-a beam, e.g., beam that was measured with highest RSRP/RSRP. The UE may monitor PDCCH on other associated SS-a beams, if no PDCCH is received or PDCCH is not decoded successfully on the best SS-b beam, The information/indications received by the UE in system/cell access information may include any of the following configurations parameters (including those described above):
One or more RACH configurations
   The resources/parameters in a RACH configuration may include any of a set of PRACH preambles. ROs in TD/FD (described above).
   In exemplary embodiments, the UE may receive indication on a first RACH configuration and a second RACH configuration, where the first RACH configuration may be associated with a non-CSI-based RACH (e.g., for RACH without CSI and beam refinement, initial access) and the second RACH may be associated with CSI-based RACH. In exemplary embodiments, the resources in the first and second RACH configurations may fully overlap, partially overlap, or not overlap in any of the time, frequency, spatial, or sequence (e.g., preamble) domains.
   The resources in the second RACH configuration may be selected and/or used for RACH transmission when meeting with a criteria condition provided in a previous section (e.g., RSRP of an SS-a beam is greater than a threshold, UL data delay is less than a threshold, paging indication with a flag indicating urgent DL data, etc.)
One or more SS-b beam configurations
   Each SS-b configuration may include a set of parameters: ID/index of an SS-b configuration, time and frequency locations of SS-b beams/signals, number of beams in a burst and number of bursts, etc.
   In exemplary embodiments, the UE may also receive the scheduling information (e.g., SFN/slot offset) associated with SS-b beams (e.g., start offset, periodicity) in the cell access information (e.g., PDCCH/SIB).
   In exemplary embodiments, the UE may receive an indication (e.g., flag) indicating whether or not any SS-b configurations/beams are active or any SS-b beams are expected to be transmitted. Such an indication on active SS-b configurations may be associated with always-on SS-b configurations or on-demand SS-b configurations.
One or more CSI configurations (e.g., for early beam refinement)
   Each configuration may include a set of parameters: ID/index of a CSI configuration, ID/index of resource configuration/set (e.g., SS-b configuration), report type (e.g., semi-persistent, aperiodic), report quantity (e.g., index of SS-b beam with highest RSRP, RSRP of SS-b beams), PUCCH/PUSCH resources for CSI reporting (e.g., periodic, semi-persistent, aperiodic resources), etc.

In exemplary embodiments, the UE may determine the applicable CSI configuration for a configured/indicated SS-b beam/configuration based on the association information between the RACH resources (e.g., ROs in TD/FD) and one or more CSI configuration. For example, the UE may be configured with the association information between a set of ROs in the time domain (e.g., TDMed RO-1, TDMed RO-2) and/or a set of ROs in the frequency domain (e.g., FDMed RO-1, FDMed RO-2), and CSI configuration with index K. In this case, when the UE selects a preamble and uses TDMed RO-1/FDMed RO-1 for transmitting the preamble, the UE may assume the CSI configuration applicable for measurements/reporting on SS-b beams may be CSI configuration with index K.

(3) UE transmits PRACH for Initiating/Requesting CSI-Based RACH and/or SS-b Beams

In exemplary embodiments described herein, the UE may perform PRACH transmission for initiating/requesting CSI-based RACH. The UE may select a RACH resource (e.g., from the second RACH configuration associated with CSI-based RACH, possibly indicated in the system/cell access information) and transmit a PRACH preamble (e.g., Msg1/MsgA) or a UL-WUS indication in the selected RACH resource (e.g., RO in TD/FD).

The UE may select a PRACH/UL-WUS resource (e.g., preamble, RO in TD/FD) that may be associated with an SS-a beam that is above an RSRP threshold and/or an SS-a beam with the highest RSRP. The UE may transmit such PRACH preamble if any of the conditions associated with requesting/initiating CSI-based-RACH (e.g., CSI measurement/reporting, beam refinement during RACH) are met. For example, if the RSRP of any SS-a beam is above a threshold and/or there is pending UL data buffered, the UE may transmit the PRACH preamble selected from the second RACH configuration. Otherwise, if any of the conditions are not met, the UE may select RACH resources from the first RACH configuration (e.g., associated with non-CSI-based RACH). If any of the conditions for selecting resources from the second RACH configuration are met but the RSRP of the SS-a beams is below a threshold, the UE may increment a count value and perform additional measurements on the SS-a beams (e.g., corresponding to additional SS-a bursts), possibly until the RSRP of SS-a increases above a threshold or the count reaches a max value.

In exemplary embodiments, when transmitting the PRACH preamble the UE may indicate the request for CSI configuration and/or on-demand SS-b configuration. Such request may be sent by scrambling at least a subset of the sequences/symbols associated with the PRACH resource/preamble with a scrambling code (e.g., predefined or indicated in PDCCH/SIB). Such a request or indications may be sent using PUCCH/PUSCH resources (e.g., predefined or indicated in SIB). In this case, the accompanying PUCCH/PUSCH may be transmitted upon transmitting the PRACH preamble. Alternatively, the UE may send the additional measurements (e.g., index of the best SS-a beam, RSRP measurements of a subset/top N/all SS-b beams), possibly when more PUCCH/PUSCH resources are available (e.g., via SIB). For example, the UE may indicate the index(s) of alternative SS-a beams (e.g., one or more SS-a beams alternative to the SS-a beam with the highest RSRP). The RSRP of such alternative beams may be above an RSRP threshold), which may then be used for monitoring the RACH response indication.

In exemplary embodiments, the UE may transmit the PRACH/UL-WUS during a RACH Occasion (RO) in any of the time or frequency domains, during which the cell may monitor for any PRACH UL-WUS transmission from the UE, for example. Such ROs may be associated with the RACH configuration (provided in the first PBCH) and/or the properties of SS-a (e.g., periodicity, time/frequency location, beams). In the case when a RO pattern is configured/indicated (e.g., comprised of time/frequency locations, periodicity of ROs, association period with SS-b beams, RO duration, start slot/offset), the UE may transmit the PRACH during the next available RO, possibly associated with the selected SS-a beam and or within an association period with SS-a beam. If a RO pattern is not configured indicated, the UE may assume the availability of an RO N association periods SFNs/subframes/symbols (e.g., N=1) after the reception of the SS-a in an SS-a burst (e.g., last symbol of SS-a in a burst), for example.

In exemplary embodiments, the UE may be configured with one or more RACH resources (e.g., preambles, sequences, ROs) that may be associated with any of different cells, SS-a signals/beams/configurations and OD-SS-b configurations/signals/beams. The UE may select a RACH resource for transmission based on whether the indication is intended to be cell-specific, SS-a-specific, or SS-b-specific. For example, the UE may select a cell-specific RACH resource when transmitting PRACH/UL-WUS to a particular cell or when requesting SS-b transmission from the particular cell. In this case, the UE may scramble the PRACH resource with a cell-specific scrambling sequence when transmitting PRACH, for example. In another example, the UE may select an SS-a-signal/beam-specific RACH resource/sequence for indicating a particular SS-a index/signal/beam that is used as a reference when transmitting PRACH. In another example, the UE may select an SS-b-signal/beam/configuration-specific RACH resource/sequence when requesting a particular SS-signal/beam/configuration or CSI configuration.

Additional triggering conditions that may be used by the UE for determining whether/when to transmit the PRACH/UL-WUS may be related to the absence of an indication on on-demand SS-b triggering (e.g., in first PBCH or SIB), absence of a RAR indication (for a monitoring duration). In this case, the UE may transmit PRACH within k time units (e.g., SFNs, subframes, symbols) upon detecting one or more of the triggering conditions. For example, in the case when always-on SS-b may be transmitted with long periodicity by the cell, the UE may transmit PRACH to request on-demand SS-transmission if the determined time gap between the fast SS-a signal and the next/nearest always-on SS-b signal is greater than a threshold corresponding to X time units (e.g., SFNs, subframes, symbols). The UE may use the nearest available RO (e.g., within an association period) from detecting the trigger, possibly within k time units, for transmitting a PRACH. Alternatively, the UE may trigger and transmit PRACH for requesting on-demand SS-a transmissions, possibly when the existing SS-a signals are insufficient (e.g., periodicity of always-on SS-a is above a threshold, RSRP measurements of SS-a is below a threshold).

Other conditions which may be monitored by the UE for transmitting PRACH/UL-WUS may include the validity timer associated with any of the RACH configuration (indicated in the first PBCH of SS-a), SS-a signal/beam, and Timing Advance timer (TAT). For example, the UE may transmit PRACH if or when the TAT is unexpired. Similarly, the UE may transmit PRACH if or when the beams validity timer has expired.

In exemplary embodiments, the UE may perform power control when transmitting a PRACH/UL-WUS indication, where the power control parameters may be determined based on the measurements of SS-a (e.g., pathloss measurements) and possibly based on the information received in the first PBCH (e.g., on the transmit power of SS-b, alpha, p0) of SS-a.

In exemplary embodiments, the PRACH indication may be transmitted with repetition (e.g., N number of transmissions), where the number of repetitions may be determined based on the RSRP/pathloss measurements made on SS-a. For example, the UE may transmit PRACH with no repetition when the measured RSRP R greater than a threshold. The UE may transmit PRACH with n1 repetitions when the measured RSRP is within a first range and with n2 repetitions when the measured RSRP is within a second range. In another example, the UE may transmit PRACH periodically, possibly for a certain duration, possibly when the indicated RACH configuration (in the first PBCH) may be associated with periodic resources.

In exemplary embodiments, the UE may start a prohibit timer upon transmitting a PRACH/UL-WUS indication. Upon starting the prohibit timer the UE may not be allowed to transmit any subsequent PRACH until the expiry of the prohibit timer or upon reception of a RAR indication.

In the case when the UE may receive an indication on any active always-on SS-b beams or active on-demand SS-b beams (e.g., requested by another UE), the UE may perform measurements on the SS-b beams based on the information/parameters associated with the CSI configuration received in cell access information (e.g., PDCCH/SIB). In such a case, the UE may skip performing PRACH transmission using in the second RACH configuration. Such skipping of the PRACH transmission may be done under certain conditions, including for example, when initial access with the cell was done before, UE Identity (e.g., C-RNTI) is available, or resources (e.g., UL-grant) for CSI reporting are preconfigured and valid.

### (4) UE Receive RAR in Response to PRACH for CSI-Based RACH

In exemplary embodiments, the UE may receive a Random Access Response (RAR) in response to transmitting a PRACH/UL-WOS indication associated with requesting/initiating CSI-based RACH and/or SS-beams. Such a RAR may be received via an explicit indication (e.g., in a DCI), possibly in a RAR monitoring configuration (e.g., common search space or CORESET) or via an implicit indication with the reception of SS-b signals beams, possibly with a certain predefined start duration after PRACH/UL-WUS transmission. In exemplary embodiments, the VE may be configured to monitor a first RAR that may be associated with CSI-based RACH (e.g., containing parameters for beam refinement and/or CSI measurements) and a second RAR that may be associated with cell access (e.g., temp UE ID).

For receiving an explicit RAR, the UE may be configured (e.g., as indicated in a first PBCH or SIB) with time frequency monitoring resources, which the UE may monitor for a certain time window (e.g., configured with a start time and duration in terms of SFNs, subframes, symbols, ms), possibly with a certain periodicity. The UE may start the time window for receiving the RAR. possibly within m time units of transmitting the last PRACH indication. For example, the UE may start a timer associated with the RAR window m symbols slots (e.g., m≥1) after transmitting PRACH. The UE may monitor for a RAR while the timer is running, for example. The UE may stop and reset the timer upon receiving a RAR indication, for example.

In exemplary embodiments, the RAR may be received in the PDCCH monitoring occasions (PMOs) associated with at least the beam (e.g., SS-a beam) used for PRACH transmission. In this regard, the UE may monitor the RAR using one or more receive spatial filters (e.g., ports, weights) and beams that may be associated with the spatial filters used for PRACH transmission (e.g., same beam and beams that are spatially nearby). The RAR may be received in PMOs associated with one or more beams other than the beam used for PRACH, possibly when receiving a configuration or indication (e.g., in the first PBCH or SIB).

The RAR indication may be received in any of the following:
L1/PDCCH signaling
   Such indication may be received in a DCI, including in any of cell-common, group-common, or UE-dedicated DCI formats.
   Such DCI may include any of a CSI-based RACH response DCI (e.g., scrambled with a new RNTI), RACH response DCI (e.g., scrambled with RA-RNTI), SI DCI (e.g., scrambled with SI-RNTI), paging DCI (e.g., scrambled with paging DCI). paging early indication DCI (e.g., scrambled with PEI-DCI), wake-up or LP-WUS DCI and measurement related DCI (e.g., aperiodic CSI trigger)
   Such DCI may include any of scheduling or non-scheduling DCI formats, possibly when received in CONNECTED mode.
   In exemplary embodiments, such indication may be received in a new signal or channel that may be encoded with a sequence that may be detected/decoded by the UE. Such a signal may include any of LP-SS transmission, and first/second/third sync signal.
L2 signaling
   Such indication may be received in PDSCH, MAC CE or any access stratum (AS) layer signaling such as PDCP or RLC control PDU, possibly when received in CONNECTED mode.
   Such indication in PDSCH/MAC CE may be associated with the PDCCH/DCI for RAR.
L3/RRC signaling
   Such indication may be received in any dedicated RRC messages for a UE in CONNECTED/INACTIVE mode, or in broadcast messages (e.g., first PBCH of SS-a, PBCH of SS-b, MIB, SIBx) for a UE in IDLE mode.

In exemplary embodiments, the received RAR indication may include one or more of the following information/parameters. Some of the information/parameters may be the same or updates to the information included in the first PBCH of SS-a (e.g., UE may use latest parameters indicated in the WUS response) or system/cell access information (SIB). The remaining information parameters in the RAR may be new which are not includes in the first PBCH or SIB. The information/parameters in the RAR may include:
Identities
   e.g., RACH preamble ID (RAPID), Temporary C-RNTI (Temp UE ID)
status of SS-b transmission
   e.g., may indicate whether SS-b beams (e.g., always-on or on-demand) are transmitted or not transmitted. For example, when bit value ‘0’ in an associated bitfield of the RAR is received, the UE may assume SS-b is not transmitted by the cell. Similarly, when bit value ‘1’ in an associated bitfield of the RAR is received. the UE may assume SS-b is transmitted by the cell.
index of SS-b configuration
   e.g., may indicate the SS-b configuration that may be expected to be transmitted by cell.
index/ID of CSI configuration
   e.g., may indicate the CSI configuration (e.g., CSI resource configuration and/or CSI report configuration) that may be used by the UE for CSI measurements and reporting on SS-b beams.
(subset) of parameters of SS-b
   e.g., may include any of the periodicity, duration, time location in terms of start time offset (e.g., with respect to a reference time point including PRACH transmission time, start/end of monitoring window, last SS-a transmission) and frequency location in terms of frequency offset (e.g., with respect to a reference frequency point, including center frequency of SS-a, center frequency of carrier)
SFN
   e.g., may indicate the SFN value where an SS-b beam is located (e.g., nearest/next SS-b beam with respect to a reference SEN or a reference SS-a beam index)
indication of RACH resource/configuration
   e.g., may indicate index/ID associated with the RACH resource/configuration that may be selected and used by the UE (e.g., preamble index, sequence index/ID)
scaling factor for periodicity of SS-b
   e.g., may indicate that the periodicity of SS-b is some scaling factor (e.g., 2×) that of SS-a
scaling factor value for the duration of on demand SS-b
   e.g., scaling factor may indicate the duration of SS-b (e.g., in terms of N number of bursts, ms) is K multiple of the periodicity of SS-a (e.g., where K<1 and K>=1)
Indication of priority
   e.g., may indicate the priority value associated with the activated SS-b configuration
   In exemplary embodiments, when any of the SS-b beams associated with different. always-on SS-b and on-demand SS-b configurations overlap in any of the time, frequency, or spatial domains, the UE may use the indicated priority value for determining which of the SS-b beams to select and/or use, such as for measurements, cell (re)selection, initial access, etc. In this case, the UE may select the SS-b beams associated with the SS-b configuration with the highest priority, for example.
Indication of UL grant allocation
   Such an indication may include the parameters associated with one or more UL grants. Such parameters may include any of time domain/frequency domain resource allocation (TDRA/FDRA) for PUSCH, MCS, port index, etc.
   In exemplary embodiments, a first UL grant may include PUSCH resources for transmitting RRC request messages (e.g., setup request) in Msg3.
   A second UL grant may include the PUSCH resources for transmitting the CSI report associated with measurements on SS-b beams. For example, the second UL grant may consist of multiple conditional grants, where each grant may be associated with a different set of resources/parameters (e.g., TDRA, MCS) for transmitting different payload sizes The conditions for transmitting data in accordance with a second UL grant with a particular payload size may be related to the RSRP of SS-a/SS-b beams (used for PRACH transmission), RSRP of PDSCH associated with the received RAR indication (e.g., DMRS of PDSCH), priority of CSI report, etc. For example, the UE may transmit data with payload size xl (containing a first CSI report) in accordance with a second UL grant if the RSRP of SS-beams (e.g., average, maximum) is within a threshold range1, Otherwise, if the RSRP of SS-b beams is within a threshold range2, the UE may transmit the second UL grant with a payload sire x2 (e.g., x2×x1).
Indication of additional resources
   May indicate an index to a predefined/preconfigured set of additional resource configurations in time and/or frequency domain, and may include those related to configured grant resources or small dam transmission resources.
   In exemplary embodiments, an additional resource configuration may be implicitly indicated based on the presence of a bit (e.g., with value ‘1’) in a bitfield which may indicate allocation of additional resources and the association between the additional resource configuration and a property of SS-b (e.g., periodicity or duration of SS-b). For example, 2 bits in a bitfield may indicate one of 4 additional resource configurations which may be associated with the periodicity/duration of SS-b.
   May indicate the validity of the additional resource configuration, including time validity (e.g., timer value) and spatial validity (e.g., list of cells/PCIs).
   May indicate whether the additional resource configuration may be associated with any of periodic, semi-persistent (e.g., periodic over a time duration/window), or aperiodic resources.
Transmit power parameters
   E.g., may indicate at least one of predefined/preconfigured Transmit power values used for SS-b signals. Such transmit power may be used by the UE for pathloss estimation and/or for determining the transmit power for any UL transmissions (e.g., PRACH associated with SS-b beam).
   In exemplary embodiments, the transmit power for SS-b may be indicated as an offset or scaling value that may be applied to the transmit power of SS-a or a reference power value (e.g., maximum transmit power). In this case, the UE may determine the transmit power of SS-b based on the transmit power of SS-a and the corresponding power offset value, for example.
   Other parameters that may be indicated in the RAR may include index(es) to po and/or alpha values, which may be associated with power control.
Indication on the activation/deactivation of NES adaptations/states
   Such indication may indicate the NES adaptation schemes (e.g., IDs/indexes) such as SD/PD adaptations and cell DTX/DRX, based on which the UE may determine/identify the associated SS-b configurations, for example.
   In exemplary embodiments, such indication may include the timing information (e.g., in terms of absolute time symbols/slots/ms or relative time with respect to reference symbols/slots/ms) indicating when the NES adaptation is expected to start and/or end.

In exemplary embodiments, when the RAR indicates that additional resources are available for UL transmission, the UE may transmit an indication including any of: a request to increase SS-b repetitions; a request to change the periodicity of SS-b; a CSI measurement report related to the measurements made on SS-a/SS-b; an ID/index of a PRACH resource; or a request for one or more SI. Such indications/information may be transmitted by the UE using with any of a PRACH preamble, MSG-A, and small data transmission, possibly using the indicated resources.

In exemplary embodiments, if a RAR is not received by the UE before the end of the monitoring window or before the expiry of a RAR timer, the UE may monitor for an implicit RAR in the form of initiation of new SSBs, including any of new SS-a, new always-on SS-b, or new on-demand SS-b transmissions. For example, the first PBCH in SS-a received after the monitoring window may include a RAR indication (e.g., in an associated bitfield of first PBCH). The monitoring for new SSBs may be done by the UE, for a certain time duration, before and/or after the end of the monitoring window or the expiry of the RAR timer. The UE may select a new SSB based on measurements (e.g., L1 RSRP) and using criteria associated with the measurements (e.g., measured RSRP of the new SSB is above a threshold value and/or is the highest among the detected new SSBs). The UE may transmit a PRACH preamble associated with the selected new SSB beam and may receive the RAR.

In another example, if an explicit RAR is not received by the UE before the end of the monitoring window or before the expiry of the RAR timer, the UE may retransmit the PRACH, possibly after the expiry of any associated prohibit timer. The UE may retransmit the PRACH indication for N configured instances/attempts, before termination and/or releasing any RACH configuration. For example, the UE may use any of the associated information (e.g., RACH configuration, indication on SS-b transmission, transmit power parameters) in the latest first PBCH of SS-a when retransmitting PRACH. The UE may also reselect the RACH resources associated with a new selected SS-a when retransmitting the PRACH.

### (5) UE Receives SSB-b Beams From a Cell

In exemplary embodiments, the UE may receive one or more SSB-b beams (containing e.g., sync signals, PBCH, MIB/SI). Such SS-b beams signals may be associated with at least one active SS-b configuration (e.g., always-on or on-demand). Such SS-b beams may be received by the UE when supporting any functions associated with IDLE mode (e.g., cell (re)selection, synchronization, SI update, paging) and/or CONNECTED mode (e.g., L1/L3 measurements, RLM, BM). In exemplary embodiments, the UE may receive the SS-b beams in one or more bursts, e.g., number of bursts associated with SS-b configuration.

In exemplary embodiments, upon determining the locations of SS-b beams, possibly based on the information provided via SS-a beams, cell access information (SIB), and/or RAR, the UE may start monitoring at least the nearest determined candidate locations from the last received SS-a beam (e.g., next candidate SEN from the SEN of the last SS-a) for receiving the SS-b beams. The received SS-b beams may be used for any of measurements, cell (re)selection, paging, initial access, etc.

In exemplary embodiments, the UE is configured to perform measurements on SS-b beams In exemplary embodiments, the UE may receive an indication (e.g., in RAR) on CSI configuration, where the CSI configuration may be associated with an SS-b configuration. When in CONNECTED mode, such indication may be received in any of L3/RRC, L2, or L1/DCI signaling. For a UE in IDLE mode, such indication may be received in any of SIBx, paging message (e.g., L1/DCI indication), initial access messages (e.g., Msg2, MsgB, Msg4), or RAR mess age. Such indication may indicate a request to perform measurements on the one or more SS-b signals beams in the SSB-b configuration, for example. The indicated SS signals/beams ma be in the general direction where the UE may be located (e.g., a subset of SS-b beams compared to the beams in SS-a). Such SS-b beams may be transmitted by the cell, possibly for a limited time duration (e.g., for energy savings) for the UE to perform enough measurements and possibly for cell switch/cell reselection to the associated cell, for example.

In exemplary embodiments, the UE may determine the spatial relation and/or timing information for performing measurements on the one or more SS-b beams. Such spatial relation and timing information may be determined based on at least the CSI configuration (e.g., associated with the SS-b configuration) and information on IDs/index(es) of the SS-b beams that may be indicated by the NW. For example, the UE may determine the spatial relation (e.g., parameters for spatial receive filter) to apply for receiving the indicated SS-b beams based on the spatial receive filter applied for the SS-a beams in the SS-a configuration and the configured QCL/spatial association relation information that associate both SS-a and SS-b configurations. In this case, the association information (preconfigured in the UE) may indicate the relationship/mapping between the indexes of SS-a signals beams in an SS-a configuration and the indexes of SS-b signals beams in an SS-b configuration. For example, when using spatial relation x for receiving a wide-beam SS-a with index i, the UE may use the same spatial relation x for receiving any of the narrow-beam SS-b beams with indexes {a, b, c, d, e}. In another example, the UE may monitor for the set of SS-b beams using a spatial filter associated with at least the SS-a beam used for PRACH/WUS transmission. For the timing information, the UE may determine the timing for receiving the indicated SS-b beams based on the timing of the SS-a beams and the configured association information regarding the timing relation.

The UE may perform measurements (e.g., according to the parameters in the CSI configuration) on the indicated SS-b beams received from the indicated cells. Such measurements possibly on the one or more narrow beams of SS-b, may be associated with any of L3, L2, and/or L1 measurements. When performing measurements on the SS-b beams, the UE may apply the spatial relation (e.g., spatial receive filters) that was applied when making measurements on the SS-a beams that may be in QCL/spatial relation with the indicated SS-b beams, for example.

From a set of one or more SS-b narrow beams, the UE may perform measurements (e.g. L1/L3 measurements) on the received beams and may select a best SS-b narrow beam based on the measurements. For example, the UE may select an SS-b narrow beam based on the beam that has the highest RSRP.

### (6) UE Sends Msg3 During RACH

In exemplary embodiments described herein, the UE may send a message such as an RRC setup request or resume (e.g., Msg3), possibly in accordance with the first UL grant received in the RAR indication (e.g., a UL CCCH message indicating RRC setup request or resume). The message may include at least the UE identity (e.g., a random bit string of b-bits or S-TMSI) and a cause indication (e.g., connection establishment or resume request).

In exemplary embodiments, the cause indication may include any of the request messages associated with CSI-based RACH (as described above), including a request for SS-b configuration/beams (e.g., configuration/beam indexes), request for CSI configuration, etc. Such a cause indication, indicating the request for CSI-based RACH, may be transmitted in Msg3, if a RACH configuration (e.g., RACH resources) associated with CSI-based RACH was not configured or received in cell access information (e.g., in SIB).

In exemplary embodiments, if the CSI report is ready for transmission and the second UL grant is available, the UE may transmit the CSI report in Msg3, possibly along with other information (e.g., RRC setup request, cause indication, UE identity) if there are further resources in the second UL grant. Otherwise, if the CSI report is not ready or there are no resources available in the grant, the UE may transmit Msg3 using the first UL grant (e.g., provided in RAR) and transmit the CSI report using the second UL grant.

In exemplary embodiments, if SS-b beams are received (e.g., upon PRACH transmission and RAR reception), the UE may transmit the Msg3 via the best SS-b beam (e.g., the beam with the highest RSRP). If SS-b beams are not received or the RAR For CSI-based RACH is not received, the UE may transmit Msg3 via the SS-a beam used for transmitting PRACH/UL-WUS.

### (7) UE Receives Msg4 During RACH

After transmitting Msg3, the UE may receive a contention resolution indication (e.g., in Msg4). The contention resolution indication may include any of: the UE identity (e.g., the same identity as indicated in Msg3), C-RNTI, RRC setup message, a copy of the UL CCCH message sent by the UE, and/or the second UL grant (e.g., if not included in the RAR). For example, the UE may use the resources indicated in the second UL grant for transmitting the CSI report associated with the measurements made on SS-b beams. In the case when the second UL grant is provided in RAR, the second UL grant provided in Msg4 may replace the previous grant and the UE uses the resources indicated in the latest provided grant. Alternatively, the UE may use the resources indicated in the second UL grant provided in the RAR for sending a first CSI report (e.g., containing a subset of measurements and/or higher priority measurements) and the resources indicated in the second UL grant provided in Msg4 for sending a second CSI report (e.g. containing another subset of measurements, lower priority measurements, an update to the measurements).

### (8) UE Sends a CSI Report Containing Measurements on SS-b Beams

In the examples described herein, the UE may send a CSI measurement report, possibly to the cell from which the UE received the CSI configuration (e.g., serving cell or camping cell). including RSRP measurements of the SS-b beams. When in CONNECTED mode, the UE may send the report/indication in any of RRC signaling, L2 signaling (e.g., UL MAC CE), or L1 signaling (e.g., UCI, PUCCH, PUSCH). When in IDLE mode, the UE may send the report/indication, at least in part, in any of initial access messages (e.g., Msg1, MsgA, Msg3, Msg5), UL WUS resource signal, or a common set of resources (e.g., PUCCH/PUSCH) possibly accessed on a contention basis,

In exemplary embodiments, the CSI report may be sent with Msg3 (e.g., if CSI report is ready in an occasion associated with Msg3 or a UL grant is available that may fit the payload of the CSI report). Otherwise, the CSI report may be sent after sending Msg3 (e.g., containing RRC setup/resume request), before receiving Msg4, or after receiving Msg4.

The CSI report sent by the UE may include one or more of the following:
index of a selected SS-b beam (e.g., beam with highest RSRP and/or RSRP above a threshold value)
RSRP of the selected SS-b beam
RSRP of a set of SS-b beams (e.g., K configured/indicated beams including all active SS-b b beams in a burst, K beams with highest/lowest RSRP)
other CSI measurement parameters (e.g., RI, LI PMI)
UE identifier(s)
   C-RNTI (if Msg4 is received before the time occasion of second UL grant)
   Random bitstring/S-TMSI (f Msg4 is not received before the time occasion of second UL grant)

In exemplary embodiments, the UE may transmit the CSI report via the beam (e.g., SS-a beam) used for transmitting PRACH/UL-WUS or Msg3. Such transmission using the beam for PRACH may be done if the RSRP of the best SS-b beam (e.g., SS-b beam with highest RSRP) is below a threshold and/or the RSRP of the best SS-a beam is above a threshold. The UE may transmit the CSI report via the best SS-b beam if the RSRP of the best SS-b beam is above a threshold.

### (9) UE Receives Confirmation Indication on Beam Refinement

In exemplary embodiments, the UE may receive an indication of confirmation of beam refinement. Such an indication may be received in the PDCCH or in the PDSCH associated with the PDCCH. The indication may include, for example, the index of an SS-a or SS-b beam (such as the beam indicated in the CSI report or another beam), or the UE identity (e.g., C-RNTI).

In exemplary embodiments, upon transmitting the CSI report or Msg3, the UE may monitor the PMOs for the PDCCH associated with the confirmation indication on the beam used for transmitting the CSI report or Msg3 (e.g., best SS-b beam). Upon receiving the confirmation indication, the UE may switch to a spatial filter associated with the reported/received SS-b beam for subsequently receiving PDCCH/PDSCH or transmitting PUCCH/PUSCH.

In exemplary embodiments, the UE may receive, such as in the confirmation indication, a command to perform cell-switch/handover/cell reselection to a cell (as indicated, for example, with the ID/index of the cell). The UE may perform cell switch/cell reselection to the indicated cell by transmitting any of a PRACH preamble or a UL indication (e.g., UL WUS signal, PUCCH/UCI/SR) using the provided resources. The UE may select a best SS-b beam, possibly selected based on the highest RSRP measured, for transmitting the UL indication associated with the selected cell.

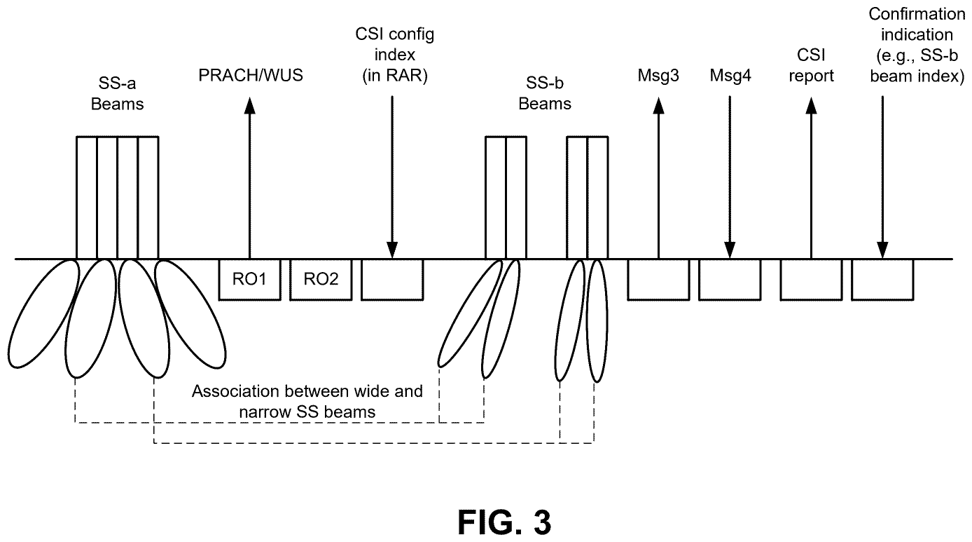

FIG. 3 illustrates an exemplary CSI-based RACH procedure involving the steps of SS-a (wide-beam) reception, PRACH/UL-WUS transmission, RAR reception, SS-b (narrow-beam) reception, CSI report transmission, and confirmation indication reception.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication cap devices. (e.g., radio wave emitters and receivers). However, the embodiments discussed are not limited to these systems but may be applied to other systems that use other forms of electromagnetic waves or non-electromagnetic waves such acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software embodiments of aspects of systems. The use of hardware or software is generally (but not always, in that in certain contexts the choice between hardware and software may become significant) a design choice representing cost versus efficiency tradeoffs. There may be various vehicles by which es and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software embodiment. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog. communication medium (e.g., a fiber optic cable, a waveguide, a wired communications link, a wireless communication link, etc.).

Those skilled in the art will recognize that it is common within the art to describe devices and/or process in the fashion set forth herein and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the an that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted. as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together. B and C together, and/or A, B, and C together, etc.). In those instances where a convention analogous to “at least one of A, B, or C, etc.” is used, in general such a construction is intended in the sense one having skill in the an would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of” “any combination of” “any multiple of” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality.”

Any term ending with the suffix ‘(s)’ is to be interpreted as ‘one or more’ and ‘at least one’. The term ‘may’ is to be interpreted as ‘may, for example’, A symbol ‘/’ (e.g., forward slash) may be used herein to represent ‘and/or’, where for example, ‘A/B’may imply ‘A and/or B’.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the tens “means for” is not so intended.

1. A method performed by a wireless transmit/receive unit (WTRU), the method comprising:
receiving first reference signal beams from a wireless network;
performing measurements on the first reference signal beams;
receiving, from the wireless network, configuration information for a channel access procedure based on channel state information (CSI);
transmitting a channel access request to the wireless network based on the measurements on the first reference signal beams and the configuration information;
receiving a response to the channel access request;
receiving second reference signal beams from the wireless network;
performing measurements on the second reference signal beams;
transmitting to the wireless network a CSI report based on the measurements on the second reference signal beams; and
receiving a beam refinement confirmation indication from the wireless network.

2. The method of claim 1, wherein the WTRU is configured with configuration information including one or more of:
configuration information for the first reference signal beams,
configuration information for the second reference signal beams,
channel access procedure configuration information,
CSI configuration information,
control resource set or search space set configuration information,
application time information for at least the first reference signal beams or the second reference signal beams,
validity information for at least the first reference signal beams or the second reference signal beams, or
network energy savings (NES) information.

3. The method of claim 1, wherein at least one of transmitting the CSI report or receiving the beam refinement confirmation indication occurs during the channel access procedure.

4. The method of claim 1, wherein at least one of:
the CSI report is transmitted in a WTRU identification message, a setup message, or a resume message, or
the beam refinement confirmation indication is received in a contention resolution message.

5. The method of claim 1, comprising receiving, using spatial filtering, at least one of a downlink control message or a downlink data channel, wherein the spatial filtering is associated with the first reference signal beams or the second reference signal beams.

6. The method of claim 1, comprising transmitting, using spatial filtering, an uplink control message or an uplink data channel, wherein the spatial filtering is associated with the first reference signal beams or the second reference signal beams.

7. The method of claim 1, wherein:
the first reference signal beams are wide-beam, and
the second reference signal beams are narrow-beam.

8. The method of claim 1, wherein:
the channel access procedure is a random access channel (RACH) procedure,
the configuration information for the channel access procedure is received in one or more system information blocks (SIBs),
transmitting the channel access request includes transmitting a random access preamble on a physical random access channel (PRACH), and
the response to the channel access request is a random access response (RAR).

9. A wireless transmit/receive unit (WTRU) comprising:
a processor, memory, and transceiver which configure the WTRU to:
receive first reference signal beams from a wireless network;
perform measurements on the first reference signal beams;
receive, from the wireless network, configuration information for a channel access procedure based on channel state information (CSI);
transmit a channel access request to the wireless network based on the measurements on the first reference signal beams and the configuration information;
receive a response to the channel access request;
receive second reference signal beams from the wireless network;
perform measurements on the second reference signal beams;
transmit to the wireless network a CSI report based on the measurements on the second reference signal beams; and
receive a beam refinement confirmation indication from the wireless network.

10. The WTRU of claim 9, wherein the WTRU is configured with configuration information including one or more of:
configuration information for the first reference signal beams,
configuration information for the second reference signal beams,
channel access procedure configuration information,
CSI configuration information,
control resource set or search space set configuration information,
application time information for at least the first reference signal beams or the second reference signal beams,
validity information for at least the first reference signal beams or the second reference signal beams, or
network energy savings (NES) information.

11. The WTRU of claim 9, wherein the WTRU is configured to transmit the CSI report or receive the beam refinement confirmation indication during the channel access procedure.

12. The WTRU of claim 9, wherein the WTRU is configured to at least one of:
transmit the CSI report in a WTRU identification message, a setup message, or a resume message, or
receive the beam refinement confirmation indication in a contention resolution message.

13. The WTRU of claim 9, wherein the WTRU is configured to receive, using spatial filtering, at least one of a downlink control message or a downlink data channel, wherein the spatial filtering is associated with the first reference signal beams or the second reference signal beams.

14. The WTRU of claim 9, wherein the WTRU is configured to transmit, using spatial filtering, an uplink control message or an uplink data channel, wherein the spatial filtering is associated with the first reference signal beams or the second reference signal beams.

15. The WTRU of claim 9, wherein:
the first reference signal beams are wide-beam, and
the second reference signal beams are narrow-beam.

16. The WTRU of claim 9, wherein:
the channel access procedure is a random access channel (RACH) procedure,
the configuration information for the channel access procedure is received in one or more system information blocks (SIBs),
transmitting the channel access request includes transmitting a random access preamble on a physical random access channel (PRACH), and
the response to the channel access request is a random access response (RAR).
